(19) United States
(12) Patent Application Publication
(10) Pub. No.: US 2017/0361358 A1
(43) Pub. Date: Dec. 21, 2017

(54) RUN-THROUGH CLEANING DEVICE AND CLEANING METHOD THEREFOR

(71) Applicant: OSSBERGER GmbH + Co KG, Weissenburg (DE)

(72) Inventors: Markus Huettinger, Wemding (DE); Karl-Friedrich Ossberger, Weissenburg (DE)

(21) Appl. No.: 15/623,762

(22) Filed: Jun. 15, 2017

(30) Foreign Application Priority Data
Jun. 16, 2016 (DE) 10 2016 111 050.7
May 30, 2017 (EP) 17 173 583.0

(51) Int. Cl. B08B 3/04; A47L 15/24; B08B 3/02; B65G 45/22; B05B 1/00

(52) U.S. Cl. CPC B08B 3/042; A47L 15/248; B05B 1/005; B65G 45/22; B08B 3/022

(57) ABSTRACT

A run-through cleaning device for bulk parts as well as a cleaning method therefor. Within the run-through cleaning device, the bulk parts are moved by means of a forced advance. By means of chicanes and/or a curvilinear course of the channel interior, the mutually abutting front ends of adjacent bulk parts are made accessible. Due to this arrangement, it is possible to also clean the front ends.

### CROSS REFERENCE TO RELATED APPLICATIONS

Pursuant to relevant portions of 35 U.S.C. §119, this application claims the priority of German Patent Application No. DE 10 2016 111 050.7, filed on Jun. 16, 2016 and European Patent Application No. EP 17 173 583.0, filed on May 30, 2017. The entire content of the priority applications is incorporated herein by reference in their entirety.

### Field of the Invention

The present invention is related to a run-through cleaning device for bulk parts which come for example from a machining or processing machine, like screws, pellets, turned parts or the like, as well as a cleaning method of such bulk parts, which is realized by means of the run-through cleaning device.

### Background of the Invention

After the production of multi-bulk parts, as for example turning parts for ball bearings, pellets, connection elements and the like, the surfaces thereof are contaminated among others with chippings due to the machining, lubricants and/or coolants as well as possibly with oil. Especially at highly precise components or components with low wear and tear tolerances, it is necessary to remove any dirt residues from the component surface. As this requires costly cleaning processes, one tries to automate such cleaning processes as far as possible and to adapt them to a high throughput of parts.

In this context, DE 102 26 808 A1 proposes a cleaning device for surfaces. Here, the object is to clean the surfaces from dusts and particles by means of linear brushes. These linear brushes are moved transverse to the surface of the component. To support this cleaning further by means of the linear brushes, liquid and air supply nozzles are arranged between the linear brushes. Due to the arrangement of these nozzles between two adjacent linear brushes, these brushes form a chamber-like arrangement in which the cleaning process takes place. This arrangement is, however, only useable for surfaces as for example at bulk parts having a circumferential component surface only a one-sided cleaning would be possible.

A further arrangement is disclosed in DE 37 10 367. Here, the bulk parts are moved on a conveyor belt and are blown off by means of air nozzles. As this cleaning process does not take place in a closed channel, the entry of additional contaminants by the surrounding is readily possible. Further, the conveyor belt used leads to the consequence that contaminants which are removed at first, for example at the beginning of the cleaning course, are transported forward by means of the conveyor belt. In this way, it is more easily possible that contaminants are dragged along with the bulk parts to be cleaned.

DE 10 2014 103 542 A1 in turn describes a cleaning chamber in which the components to be cleaned are introduced. Within this cleaning chamber, besides pressurized air, also steam is blown into the cleaning chamber as cleaning medium. The combination of pressurized air and steam shall ensure a better blowing off of the machining or working residues from the component surface.

DE 101 22 992 C1 describes a cleaning device for de-oiling bulk parts with structural surface by means of pressurized air jets. For this purpose, the bulk parts are supplied to the cleaning device in a continuously forced advance. This forced advance guides the bulk parts into a treatment chamber where they are supplied with pressurized air by slit nozzles. As the slit nozzles or generally the nozzles are arranged distributed over the complete treatment chamber, the flow of pressurized air is guided over the complete length of the treatment chamber around the components to be cleaned. The outer circumferential surfaces of the bulk parts are cleaned by this cleaning device but, however, due to the forced advance, the front ends of the bulk parts abutting at each other cover each other. This leads to the fact that lubricant residues are further present at the front ends although the bulk part has passed through or run through the cleaning chamber.

A further cleaning device results from DE 44 25 765 C2. Here, bulk parts are also moved by means of a conveyor through a channel-like cleaning arrangement. As it has been mentioned already above, a conveyor arranged within the channel leads to the fact that beside the surfaces of the bulk parts also the conveyor itself has to be cleaned for avoiding that the removed contaminants are not moved out of the cleaning channel with the bulk parts. Such a complete cleaning cannot be guaranteed when using such a conveyor. Further, mainly air is used as cleaning medium. This air is blown onto the surfaces of the bulk parts to remove possible contaminants. At the same time, this blowing off leads to a blowing up of the contaminants being present on the surfaces which are deposited after a specific time again on the surfaces. Such surfaces are provided by the other bulk parts as well as by the conveyor so that again these surfaces have to be cleaned. Thus, it has to be assumed that the here applied cleaning method in the form of blowing off by pressurized air is only limitedly efficient.

It is thus the object of the present invention to provide an improved cleaning system for bulk parts in which surface contaminations, as for example lubricant residues or chippings, can be removed reliably from all outer surfaces of the bulk parts.

### SUMMARY OF THE INVENTION

The above object is solved by a run-through cleaning device, by a modular tunnel-like channel segment as well as by a cleaning method for bulk parts according to the appended claims. Preferred embodiments and developments of the present invention result from the following description, the accompanying drawings as well as the appended claims.

The inventive run-through cleaning device for bulk parts has the following features: at least one modular tunnel-like channel segment through which the bulk parts are movable in longitudinal direction along a cleaning path in a channel interior, a conveyor device of the bulk parts which is arranged outside of the at least one channel segment, especially outside of the channel interior, and by means of which the bulk parts are movable in a row with abutment of adjacent bulk parts at each other through the at least one channel segment in a movement direction, wherein the channel interior defines constructively an at least partly curvilinear course of the cleaning path, whereby an arrangement of adjacent bulk parts to each other during a movement through the channel interior is changeable, a plurality of in and on the channel segment distributed supply conduits for media into and at least one discharge conduit, preferably a suction conduit, from the channel interior. The bulk parts are pushed through the tunnel-like channel segment in mutual abutment by means of the conveyor means arranged outside of the tunnel-like channel segment.

The above-described run-through cleaning device provides first of all a portion which is closed at least in the circumferential direction due to the channel interior through which the bulk parts to be cleaned are moved. This reduces the volume surrounding the bulk parts so that cleaning media as for example air and cleaning liquid can be specifically applied to the surfaces and can be removed therefrom again together with the contaminants. The channel remains preferably only open in movement direction of the bulk parts to be cleaned. Further, this construction choice has the advantage that the supplied and discharged media can be adjusted more precisely and with lower technical effort in an advantageous pressure range.

A further advantage of the present invention is that the bulk parts are moved through the channel in a forced advance. This is realized without a conveyor device moving through the channel. As the conveyor device supports the transporting and maintaining of contaminants, it has been specifically avoided. For allowing, however, at the used forced advance also the access to and the cleaning of the front ends of adjacent mutually abutting bulk parts, the channel interior is qualified by an at least partly curvilinear course of the cleaning path of the bulk parts. This means that the bulk parts move not solely straight or in unchanged orientation of adjacent bulk parts with respect to each other through the run-through cleaning device. As they follow the curvature of the cleaning path defined by the channel interior, at least at specific positions or in specific portions of the cleaning path in the channel interior, the mutual abutment of adjacent bulk parts is reduced at the front ends preferably to a punctual abutment to further transmit the advance force between the bulk parts. If a preferred front end abutment of the bulk parts changes from an areal abutment to a punctual abutment, the remaining of the front end is accessible for one or several cleaning media. The punctual abutment is further preferred by means of the not straight forced guiding in the channel interior such that all surfaces and geometry features of the bulk parts are accessible for the media. The cleaning media removes then the contaminants being present there so that at the end of the channel segment or at the end of a plurality of subsequently arranged channel segments a cleaned bulk part is present. As it is described in detail below, curvatures of the cleaning path are achieved by chicanes protruding into the channel interior or by a curvilinear course of the channel interior itself

Further, it was identified as advantageous to use besides or instead of air as cleaning media also other media, preferably liquids, as cleaning media. Thus, it is preferred to use several cleaning media or air and at least one cleaning liquid or another solvent, like preferably CO₂, as cleaning media in combination to improve the removal of contaminants from the surface of the bulk parts. For example, CO₂ as solvent is used in a semi-liquid state. It is also advantageous to use an ionized gaseous medium as cleaning medium. In this way, for example plastic particles adhering to charged surfaces of the bulk part to be cleaned are detachable. An ionization of the gaseous medium like air is performed by guiding the medium through inductors. Advantageously, the supply of an ionized gaseous medium is performed especially by means of an ionization nozzle. Further, the usage of liquids serves preferably for rinsing the channel segments provided for a sole air cleaning by means of the liquid. This realizes the preferred self-cleaning of the run-through cleaning device.

According to a preferred embodiment of the inventive run-through cleaning device, the at least one channel segment is fastened and replaceable or exchangeable by means of a quick release system. This construction ensures a fast and only with a small maintenance effort realizable individual adaptation of a run-through cleaning device to a new geometry of a bulk part. Further, it is possible to detect defective channel segments without effort (inspection) and to replace them, if necessary. A further advantage is that one can react flexibly to cleaning deficiencies or any other necessity for changing the cleaning path.

According to a further preferred embodiment of the present invention, the air supply conduits are connected to a surrounding of the run-through cleaning device by or via a filter. Further, in the suction conduit for air from the channel interior a reduced pressure or vacuum compared to the surrounding pressure acting in the channel interior, preferably in a range of 0≦p≦500 hPa, is created. Contrary to the cleaning devices known from the prior art, the air is here not blown onto the surfaces of the bulk parts to be cleaned. Such a blowing onto the surfaces removes first of all contaminants from this surface but at the same time the air whirls being present lead to a deposition of the contaminants at a not predictable other surface. In this context, it has been recognized that the blowing off of contaminants leads often to a re-deposition of the contaminants on the surface of the bulk part but not to the cleaning thereof. For this purpose, it is preferred to suck air supplied to the channel interior off of the channel interior specifically by means of reduced pressure or vacuum. This suction process creates a flowing around of the bulk parts which then takes away the contaminants from the surface of the respective bulk part. The sucked in air follows the path of the lowest resistance. By changing the channel guiding, clearances between inner channel wall and bulk part are dimensioned in shape and length such that the workpiece is flowed around advantageously for the cleaning task. In this way, it can be preferably reacted also specially to the cleaning of functional surfaces as for example bores, recesses, undercuts.

According to a further preferred embodiment of the present invention, the at least one channel segment has a plurality of chicanes which protrude into the channel interior so that adjacent bulk parts during a movement through the channel interior are changeable in an orientation with respect to each other. Thus, it is preferred that the cleaning path extends only partly straight and to combine it with curvilinear extending path segments. The curvilinear course of the cleaning path causes that the mutually abutting bulk parts, especially the mutually abutting adjacent to each other bulk parts, follow this curvilinear cleaning path. In this way, the sizes of the surface areas of the mutually abutting front ends and contact points of bulk parts being adjacent to each other change in the forced advance in the channel interior. As contact points are changed for transferring the advancing movement between adjacent bulk parts, at the same time formerly blocked surface elements are unblocked for the cleaning. Thus, it is inventively preferred to use especially these curvilinear segments of the cleaning path for removing contaminants from surface segments which are especially at a straight cleaning path only hardly accessible. For creating this curvilinear cleaning path, chicanes similar to ground waves or turning points protruding into the movement path of the bulk parts are provided. These chicanes force the bulk parts during the forced advance to deviate from the straight way. In this manner, adjacent bulk parts are tilted to each other which releases surface segments to be cleaned and/or interior spaces and/or geometry features like bores or grooves.

According to a further preferred embodiment of the present invention, a plurality of chicanes protrudes against a weight force of the bulk parts and/or a further plurality of chicanes protrudes lateral to the movement direction into the channel interior. Thus, the bulk parts oriented against the gravitational force act preferably similar to ground waves on a street. Chicanes oriented lateral to this have the same effect as the ground wave-like chicanes only that they act from another spatial direction onto the bulk parts.

In this context, it is further preferred that the channel interior extends curvilinear, preferably with a radius of curvature in the range of 2 to 3 times the length of a bulk part. The radius of curvature can be larger or smaller depending on the shape of the workpiece if the geometry of the bulk parts requires it or allows it. The dimensions of the channel interior are preferably chosen such that the bulk parts to be cleaned do not tilt, jam or get stuck during their movement through the channel interior with curvilinear course or with chicanes or with a mixture of both in the channel interior. Further, the curvilinear passage of the channel interior causes in the same way as the individual chicanes that between the front ends of adjacent bulk parts at least temporarily during the movement through the channel interior a maximum opening angle of ≦40° is formed. It is also preferred to use several portions with a different radii of curvature subsequent to each other or spaced to each other in succession.

According to a further preferred embodiment of the present invention, at least two channel segments are arranged in movement direction in succession to provide different cleaning zones wherein the channel segments are separated from each other by a spaced arrangement and/or an air curtain and/or a pressure sink. The inventively preferred adjacent different cleaning zones allow a specific adaption of the cleaning to be performed to the grade of contamination of the bulk parts and/or to the specific geometry of the bulk parts to be cleaned. Accordingly, the preferred cleaning zones are used to focus on individual cleaning tasks of specific cleaning zones and not to superimpose several cleaning processes in only one cleaning zone. Thus, it is for example preferred to suck off in a first cleaning zone contaminants from the surface of the bulk part. Besides these contaminations also oil residues are sucked off from the surface of the bulk parts. As the run-through cleaning device is qualified in that it does not use a conveyor element within the channel segments, no spreading of removed contaminants or cleaning media from the first cleaning zone, here with sucked in air, into a subsequent cleaning zone takes place. In a subsequent cleaning zone then for example a cleaning liquid is applied to the bulk parts to detach contaminants. For minimizing a mutual influence of the cleaning zones, preferably these cleaning zones are separated from each other by an air curtain, a pressure sink, adapted streams or by a chicane for portions in which different media are used like the pre-cleaning by suction and/or by a rinsing zone with liquid.

According to a further preferred embodiment of the present invention, the at least one channel segment can be vibrated. While the bulk parts are supplied preferably within the channel segment with a different cleaning media and/or with air it is advantageous to apply additional cleaning energy by means of vibrations. Thus, it is not solely the task of the cleaning media or the supplied air to remove contaminants or residues from the surface of the bulk parts. Rather, by means of the vibrations of the channel segment the oscillation is transferred to the bulk parts to be cleaned so that eventual contaminants can be removed from the surface of the bulk parts more easily. Further, the vibration can be used in combination with a clocked conveyor device such that the work pieces abut in a conveying break against adjacent surfaces. The supporting and abutting surfaces are thus accessible for the cleaning. Further, the vibrating supports the conveying through the channel as friction and tilting of the bulk parts is reduced.

In a further preferred embodiment of the inventive run-through cleaning device, surrounding air is supplied to the channel interior as cleaning medium via at least one air supply conduit as media supply conduit. To this end, a vacuum is created preferably by means of a compressor and thereby, air being present in the cleaning channel is sucked off. This sucking off controls at the same time the supply of air into the cleaning channel. Thereby, preferably the parts to be cleaned are especially not blown off by means of the air supply but sucked off by means of the air discharge. The air laden with contaminants flows then via a suction conduit as discharge conduit from the channel interior via a separation device, as for example a cyclone separator, through the compressor and is then released to the surrounding.

In the compressor, the air is heated due to the dissipation power of the compressor as well as the compression of the air. For avoiding an unnecessary heating of the surrounding of the run-through cleaning device, it is thus preferred to guide the heated air after the compressor into a heat discharge device, as for example a heat exchanger, before it is released to the surrounding. The cooling efficiency of the heat discharge device can be for example controlled by means of a control valve or regulated by means of a temperature sensor in the discharge air conduit or in the cleaning channel. Further, it is preferred to release the heated air directly to the surroundings or a suction device being present at the factory.

In a specifically preferred embodiment, the media supply conduits comprise an air supply conduit by means of which cleaned and heated air can be supplied to the channel segment. To this end, a filter as well as a heating device can be provided in the air supply conduit.

It is especially advantageous, if the air supply conduit is connected to a suction conduit as discharge conduit of the channel segment via a separation device, either directly or preferably indirectly via the channel segment, so that at least a part of the air used for the cleaning is moved in a cycle or circular flow. In contrast to the above-described embodiment, a circular flow for the cleaned air as cleaning medium is formed in this way. An advantage of this is that no contaminants from the surrounding air are applied from the outside to the work pieces to be cleaned. In other words, due to the re-using of the air from the cleaning channel, the entry of contaminants from the outside is reduced without that individual filter devices have to be used in the air supply conduit. Form or shape nozzles being present in the channel segment can thus be used without adaptation. Optionally, filter mats on the nozzles may be avoided due to the clean heated air which reduces the maintenance effort of the run-through cleaning device respectively.

A further advantage of this course of procedure is that already heated air can be provided to the cleaning channel segment as cleaning medium. The heating may occur at this due to the compressor being present and/or by means of an individual heating device. Due to the heated air as cleaning medium, either the cleaning efficiency or the throughput of the run-through cleaning device in the respective channel segment can be increased. This is based on the fact that for example the viscosity of oil being present as contaminant is reduced due to the cleaning with heated air. Accordingly, the oil is present in smaller drops or beads and can be detached or released more easily from the workpiece.

Additionally, the media supply conduits of the channel segment may further comprise a fresh or surrounding air supply conduit for surrounding air as cleaning medium. The respective functioning is explained further below in detail in combination with a further preferred embodiment. To this end, the surrounding air may be filtered and/or sucked in with a fan, which is also described further below in detail.

According to a further preferred embodiment of the run-through cleaning device, a heat discharge device, especially a heat exchanger, is provided in the circular flow of air, the power of which is regulated depending on the temperature in the channel segment. For regulating the temperature of the heated air in the circular flow, a temperature sensor is provided in the channel segment. In this way, the temperature of the air used for the cleaning can be predetermined specifically. As an alternative, is also possible to provide a separate heating device downstream of the heat discharge device for specifically predetermining the temperature of the cleaned air. This is especially advantageous in case too much heat has been discharged by means of the heat discharge device and/or the heating of the air based on the compressor is insufficient.

Especially at oil as contaminant and due to the safety at work, it is preferred that the temperature of the heated air in the channel segment does not exceed preferably about 80° C. and especially preferred about 70° C. A lower limit for the temperature of the heated air in the channel segment is preferably at about 50° C. Especially preferred, the temperature of the heated air is about 65° C. With respect to the air temperature in the compressor, an upper limit of 120° C. should not be exceeded due to the flash point of the oil. In total, the cleaning efficiency can be increased by about 40% in this way compared to non-heated air. Further, the cleaning efficiency is better controllable as especially seasonal variations of the temperature of the surrounding air have no influence on the temperature of the heated air due to the circular flow of the air.

It is further preferred to provide a bypass in the circular flow of the air so that air can be discharged to the surrounding, wherein the media supply conduit comprises further a fresh air conduit for supplying surrounding air, which preferably supplies surrounding air via a filter. Due to this construction, on the one hand cleaned and heated air can be supplied to the channel segment for improving the cleaning efficiency. On the other hand, surrounding air being already cleaned due to the filter can be supplied to the channel segment so that the cleaned workpiece can be cooled at least partly. A respective separation in the channel segment can for example occur by means of fluid mechanics so that an air mass distribution takes place by means of a specific air guiding in the channel segment. If no heated air is discharged to the surrounding via the bypass, the operation is similar to the above-described embodiment without bypass.

During operation, for example between 0 and 50%, preferably 10 to 20% of the volume flow of heated cleaned air sucked in by the compressor can be discharged via the bypass. With the fresh air conduit, quantitatively especially the volume flow which has been discharged by the bypass is supplied again. This means that 0 to 50% of the volume flow sucked in by the compressor can be supplied via the fresh air conduit. If for example 10% of the volume flow are discharged by the bypass, then 10% are supplied again by means of the fresh air conduit.

In a further preferred embodiment, a fan is provided in the fresh air conduit so that an overpressure can be provided in the channel segment. Thus, the filtered supplied fresh air or surrounding air is pressed by means of the fan into the channel segment. Due to this it is avoided that unfiltered surrounding air is sucked in via leakages being possibly present. A possible contamination of the work piece to be cleaned due to contaminants in the surrounding air is thus further minimized.

The heated and/or surrounding air is or are blown into the channel segment in which the cleaning path is present. The cleaning path receives the work piece to be cleaned and forms a nozzle in combination with the work piece to be cleaned via which air is sucked off from the channel segment. The air is supplied to the channel segment in such a manner that no suction via leakages or similar occurs but that the supplied heated and/or surrounding air, which is preferably sucked in via nozzles, flows in an appropriate manner through inlet nozzles into the cleaning path. The advantage is that existing cleaning paths can be used further without amendments and/or enhancements. The cleaning efficiency is advantageously determined by the air guiding in the channel segment. Further, it is preferred to improve the cleaning efficiency additionally by means of the adaption of the power of the used industrial manufacturing equipment to the bulk parts to be cleaned.

The preferred embodiments of the already above-described modular tunnel-like channel segment of the run-through cleaning device through which bulk parts are movable in longitudinal direction along a cleaning path in a channel interior can be summarized as follows. The modular tunnel-like channel segment has constructively an at least partly curvilinear course of the cleaning path whereby an arrangement of adjacent bulk parts to each other during a movement through the channel interior is changeable. Preferably, a plurality of media supply conduits, which are distributed over the channel segments, into and at least one discharge conduit, preferably a suction conduit, out of the channel interior are provided. Further preferred, the channel segment has at least one supply conduit of the liquid cleaning media into and a discharge conduit out of the channel interior and is fastenable with the quick release system at a basis and releasable therefrom.

Further preferred, a plurality of chicanes protrudes into the channel interior so that adjacent bulk parts during a movement through the channel interior are changeable in an orientation to each other. A plurality of chicanes is, according to different preferred embodiments of the present invention, oriented against a weight force of the bulk parts and/or a plurality of chicanes is oriented lateral to a movement direction of the bulk parts in the channel interior and protrudes accordingly into the channel interior.

As an alternative or additional to the chicanes, the channel interior extends preferably curvilinear to change the orientation of adjacent bulk parts to each other in the channel interior. According to a further preferred embodiment of the present invention, the channel segment can be vibrated in combination with an oscillator, preferably a basis.

The present invention comprises also a cleaning method for bulk parts in a run-through cleaning device, especially a run-through cleaning device according to one of the above-described embodiments, which comprises the following steps: moving the bulk parts in a row with mutual abutment at each other through at least one channel segment with a conveyor device which is arranged outside of the channel segment, supplying air to the bulk parts in a channel interior by means of an air supply conduit in connection with the surrounding and a suction conduit from the channel interior, supplying a liquid cleaning media to the bulk parts in the channel interior by means of a supply conduit and a discharge conduit, wherein the moving of the bulk parts occurs along an at least partly curvilinear cleaning path, whereby an arrangement of adjacent bulk parts to each other is changed during the movement. Further it is preferred, within the scope of the inventive cleaning method, to vibrate the at least one channel segment additionally and thus the bulk parts so that contaminants of the bulk parts can be detached from the surfaces thereof. Further, and within the scope of the inventive cleaning method, it is preferred that the supplying of air occurs with air being heated above the surrounding temperature and/or being cleaned compared to the surrounding air. At this, it is especially preferred if a suction conduit out of the channel interior is connected to the air supply conduit to provide a circular flow for cleaned heated air. Additionally, a supply of surrounding air can occur which is either sucked into the channel segment by a compressor being already present or which is supplied into the channel segment by means of an individual fan. In both cases, a cleaning of the surrounding air can occur by means of a filter before the surrounding air enters the channel segment. In combination with the fan, the filter is preferably arranged upstream of the fan. A controlling of the temperature of the heated air can occur by means of a heat discharge device and/or a heating device.

### SHORT DESCRIPTION OF THE ACCOMPANYING DRAWINGS

The preferred embodiments of the present invention are explained in more detail with reference to the accompanying drawings, in which:

FIG. 1 is a preferred embodiment of a modular channel segment of a run-through cleaning device,

FIG. 2 is an exploded view of the preferred channel segment according to FIG. 6,

FIG. 3 is a first cross sectional view through the preferred channel segment with integrated media supply and discharge,

FIG. 4 is a perspective cross-sectional view of a further preferred channel segment, with integrated media supply and discharge,

FIG. 5 is a further cross-sectional view through the preferred channel segment of FIG. 1,

FIG. 6 is a perspective view of a further preferred modular channel segment with bulk parts guided therein,

FIG. 7 is a longitudinal cross-sectional view through a preferred channel segment with bulk parts guided therein,

FIG. 8 is an enlarged depiction of a section of FIG. 7,

FIG. 9 is a further enlarged view of a section of FIG. 8,

FIGS. 10A and 10B are cross-sectional views of the preferred channel segment according to FIG. 7,

FIG. 11 is a cross-sectional view of a preferred channel segment similar to the channel segment in FIG. 7,

FIG. 12 is a longitudinal cross-sectional view through a further preferred embodiment of a channel segment,

FIG. 13 is a further longitudinal cross-sectional view through a preferred embodiment of the channel segment,

FIG. 14 is an enlarged depiction of a section of FIG. 13,

FIG. 15 is a longitudinal cross-sectional view through a preferred embodiment of the channel segment similar to the one in FIG. 13, with entry-flow geometry,

FIG. 16 is a further cross-sectional view through a preferred channel segment similar to the one in FIG. 13 with entry-flow geometry of the channel below the filter,

FIG. 17 is a further cross-sectional view through a further preferred embodiment of the channel segment similar to the one in FIG. 13 as view fromED below with exit-flow geometries of the cleaning channel,

FIG. 18 depicts several interconnected modular channel segments forming a preferred run-through cleaning device,

FIG. 19 is a depiction of several modular channel segments of a preferred run-through cleaning device and depiction of a conveyor system being arranged outside of the channel,

FIG. 20 is a flowchart of a preferred embodiment of an inventive cleaning method,

FIGS. 21A) and 21B) are schematic depictions of a preferred cross-section of the channel interior with support surfaces for a bulk part,

FIG. 22 is a block diagram of a preferred embodiment of the inventive run-through cleaning device,

FIG. 23 is a schematic depiction of a preferred embodiment of the inventive run-through cleaning device with air as cleaning medium,

FIG. 24 is a schematic depiction of a preferred embodiment of the inventive run-through cleaning device with heated air as cleaning medium,

FIG. 25 is a schematic depiction of a preferred embodiment of the inventive run-through cleaning device with heated air and cleaned surrounding air as cleaning medium,

FIG. 26 is a cross-sectional view of a further preferred embodiment of the inventive run-through cleaning device,

FIG. 27 is a perspective view of the embodiment shown in FIG. 26, and

FIG. 28 is a front-end view of the embodiment shown in FIG. 26.

### DETAILED DESCRIPTION OF THE PREFERRED EMBODIMENTS

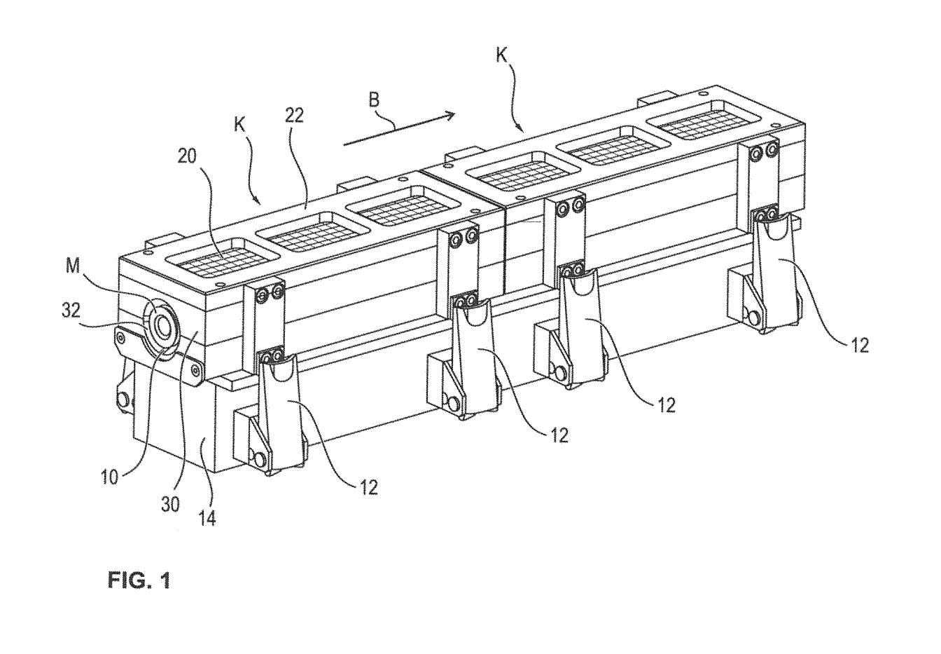

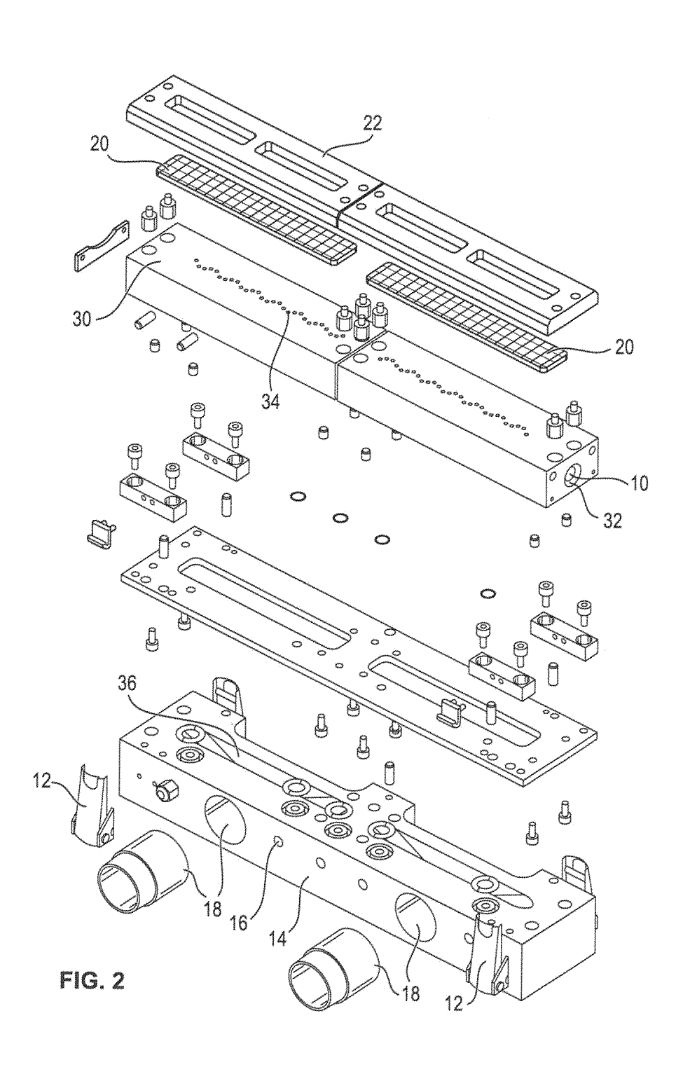

The inventive run-through cleaning device comprises at least a modular tunnel-like channel segment K. A combination of two preferred channel segments K is shown in FIG. 1. FIG. 2 shows an exploded view of a further preferred embodiment of the modular channel segment K. In the run-through cleaning device, a plurality of bulk parts M is moved in a movement direction B through a channel interior 10 of at least one modular channel segment K. For this purpose, the bulk parts M are arranged in a row in succession. A conveyor device (not shown) is arranged outside of the channel interior 10 and moves the bulk parts M in mutual abutment of adjacent bulk parts M through the channel interior 10. Thus, the bulk parts M are moved by means of a forced advance. The forced advance ensures that the conveyor device is arranged outside of the channel interior 10. Thereby, no dragging of cleaning media or of the contaminants removed from the bulk parts M occurs within the channel interior 10 by means of the conveyor device.

The bulk parts are preferably supplied by a handling system with gripping or moving unit to the channel in the correct orientation and position. These systems move the already supplied bulk parts further in movement direction B while they supply a further bulk part M. According to a further embodiment, entry systems for bulk parts are used which are arranged outside of the at least one channel interior 10. They comprise one or more contour-adapted belts, which are adapted to the outer contour of bulk parts, or conveyor belts. Generally, all conveyor systems can be used and adapted which supply the workpiece in the provided time and with the required precision to the channel segment K and move it therethrough. Accordingly, a simple conveyor belt, a high-speed conveyor with preferred cycle times of up to 120 bulk parts per minute as well as a robot with directed bulk part supply can be used.

The modular tunnel-like channel segments K are fastened via a mechanical clamping system or quick release system 12 at a basis 14 of the run-through cleaning device. The preferred quick release system 12 allows an installing and replacing of a modular channel segment K, which is fast and has a low effort.

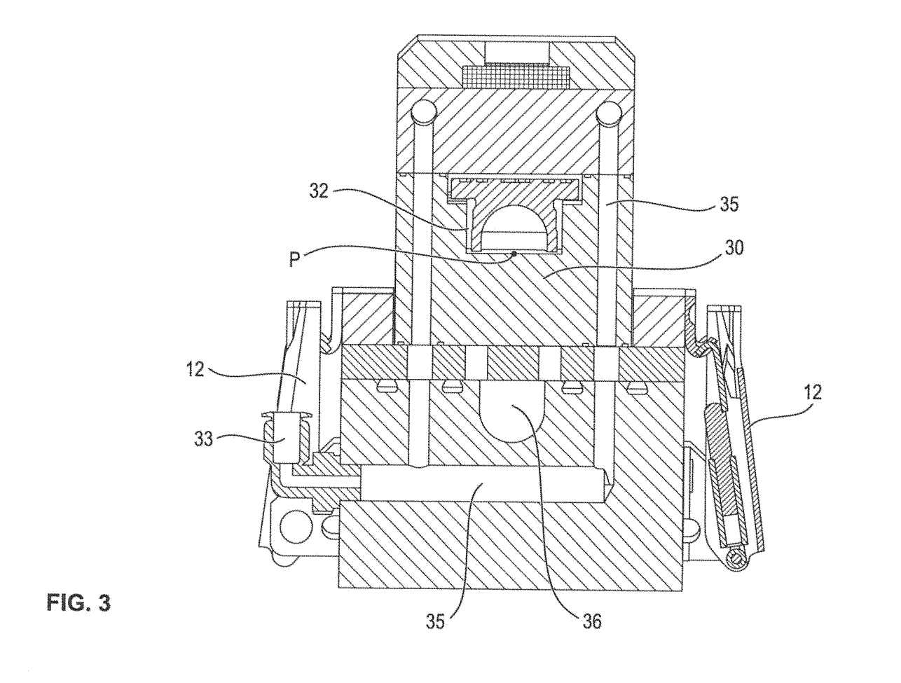

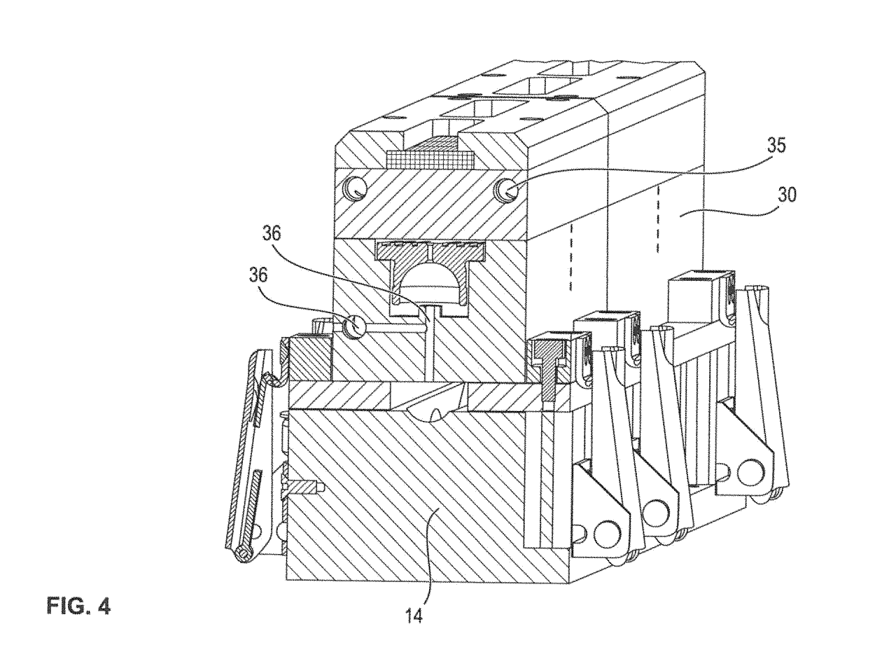

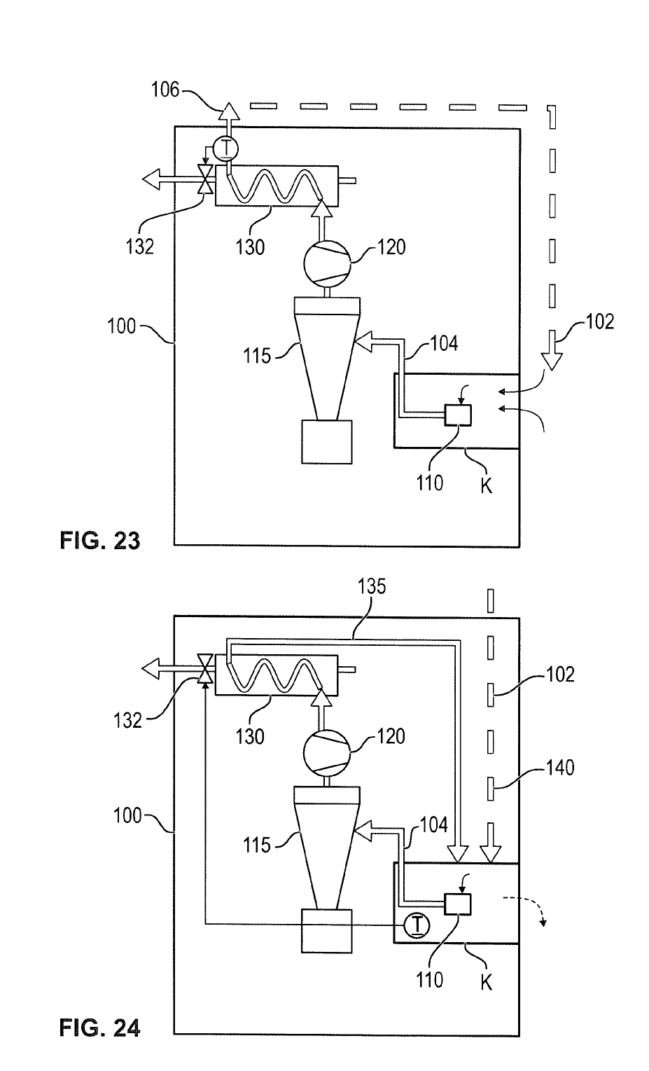

On the one hand by means of the basis 14 and its configuration and on the other hand by means of the channel segment K itself, preferably a supply and discharge of air and/or of one or a plurality of cleaning media is realized. Besides surrounding air, heated and/or dehumidified air, water, chemical cleaning liquid, cleaning gas or other suitable and known materials are understood as cleaning media. An embodiment with surrounding air and/or heated air as cleaning medium is later described in detail with reference to FIGS. 23 to 25. As can be seen based on FIG. 2, the basis 14 is traversed by a plurality of media conduits 16. These media conduits 16 are supplyable via different connections 18 with air or cleaning media. Thus, preferably surrounding air is supplied via at least one filter 20 into the channel interior 10 and discharged from there again out of the channel interior 10 by means of at least one media conduit 16 and the connection. To this end, the filter 20 is held via a holder 22 at a channel block 30. The channel block 30 provides the channel 32 with the channel interior 10. The surrounding air sucked in via the filter 20 arrives in the channel interior 10 by means of a plurality of supply conduits 34 distributed over the channel 32. The supply conduits 34 are preferably arranged at the side of the channel block 30 which faces the filter 20. At an opposite side of the channel block 30, a plurality of discharge conduits 36 are arranged via which the air and/or the cleaning media is dischargeable. Supply 34, 35 and discharge conduits 36 are for example shown in more detail in FIGS. 3 and 4.

As can be seen based on FIG. 2, the supply conduits 34 for air and 35 for cleaning media are arranged in specific patterns and/or groups with respect to the channel interior 10. By means of this arrangement, specific geometry features of the bulk parts M are streamed or flowed at and cleaned. Further it is preferred to create an air curtain in the channel interior 10 by means of a plurality of air supply conduits 34 which are arranged transverse to the movement direction B and adjacent to each other.

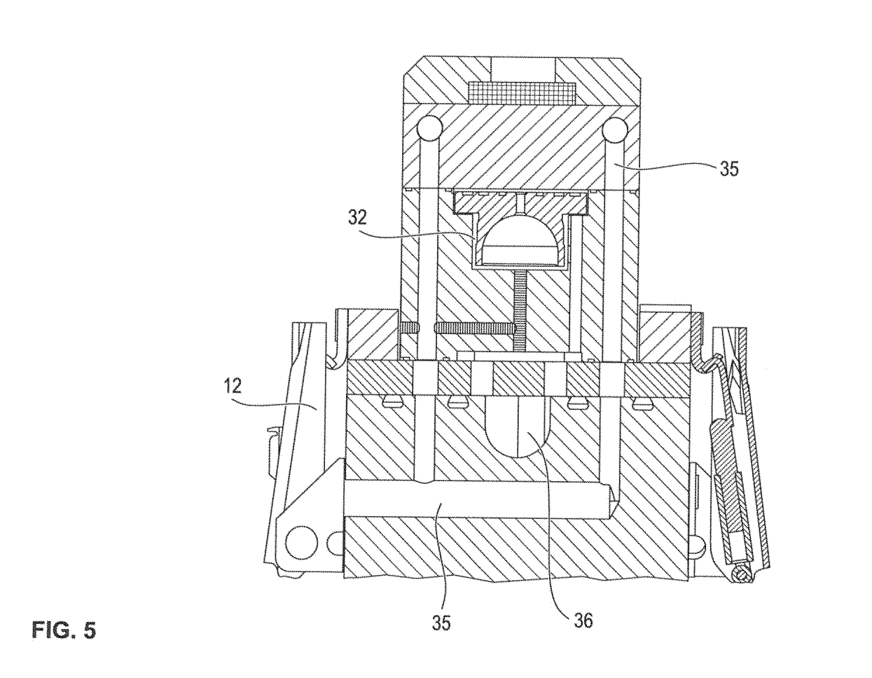

The channel 32 is shown in a preferred embodiment in its cross section for example in FIGS. 3, 4, 5, 10A, 10B, 11 and 12. In this context, preferably the cross sectional shape of the channel 32 is formed analogously to an outer cross-sectional shape of the bulk parts M. Due to the bulk parts M to be cleaned, the cross-section of the channel is preferably≦50 cm².

The channel interior 10 in the tunnel-like channel segment is preferably adapted in its cross-section to an outer shape of a bulk part M to be moved through the channel interior 10. If the bulk part M has for example a C-, H-, L-like, rectangular, polygonal, round or elliptical cross-section, preferably the cross-section of the channel interior 10 is adapted to the cross-section of the bulk part M. Due to this adaption, a clearance between the inner channel wall and the outer side of the bulk part M is reducible and can preferably be minimized to reduce the cleaning effort and thus the energy and/or media consumption of the run-through cleaning device. Preferably, the channel interior 10 comprises a maximum cross-sectional surface perpendicular to the longitudinal axis of the channel or in case of a curvilinear channel perpendicular to the cleaning path W_{R} of the bulk part in the tunnel of a maximum of 50 cm², as it has been mentioned above already.

With the above-mentioned shape adaption of the channel cross-section to the geometry of the bulk parts M, only a small gap between inner channel wall and bulk part M is realizable. Preferably, the channel cross-section transverse to the movement direction B is for example about 2-30% larger as a respective cross-sectional surface of a bulk part M. This clearance between inner channel wall and bulk part M ensures that the bulk parts M can be arranged tilted for a better cleaning during their movement to the movement direction B. This tilting, nevertheless, reaches preferably never an angle≧40° between the longitudinal axis of a bulk part M and the movement direction B or between a front end of the bulk part M and the normal to the movement direction B so that a blocking of the channel interior 10 by a bulk part M is prevented. Further, this tilting is achieved in the same way by a curvilinear course of the channel interior 10 or by chicanes 50 arranged in the channel interior 10 (see below).

The bulk parts M are moved in movement direction B by means of the forced advance through the channel 32. In the channel interior 10, the bulk parts M are flowed around by the surrounding air which is sucked in via the filter 20 and thus, contaminants are sucked off from the bulk part surfaces with the air via the ports or connections 18. If additionally or alternating thereto one or several cleaning media are supplied to the channel interior 10, the bulk parts M are cleaned during their movement by means of these cleaning media.

For supporting the cleaning, it is preferred that the bulk parts M are vibrated in the channel interior 10. According to a preferred embodiment of the present invention, the channel block 30 is vibrated by means of the basis 14. These vibrations are transferred to the bulk parts M as they are freely supported in the channel interior.

The vibrations introduced are preferably used in a range of 20-600 Hz and with an amplitude of preferably≦1.5 mm. In this context, it is also preferred to use larger amplitudes or other cleaning frequencies as far as they support the cleaning depending on contour and degree of contamination of the bulk parts M. The bulk parts are vibrated during the moving through the channel interior 10 over the complete length of the respective channel segment. To this end, it is preferred to use in different channel segments also different vibration types and/or frequencies and/or amplitudes.

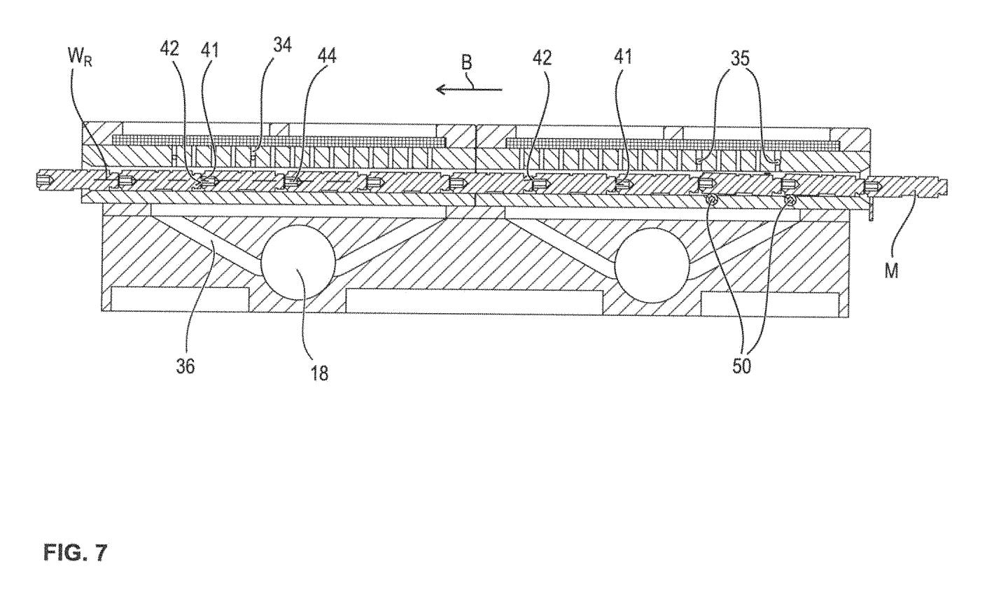

For ensuring the sufficient time of exposure of the cleaning by air, other cleaning media and vibration alone or in combination onto the bulk parts M, the velocity of the passing-through of the bulk parts M through the channel interior 10 is adjusted preferably with respect to the length of the channel interior 10. In this context, it is preferred that the bulk parts M are moved continuously or clocked through the channel interior 10. At a continuous movement, preferably the bulk parts M remain so long in the channel interior until a sufficient cleaning has been achieved. At a clocked movement B of the bulk parts M in the channel interior 10 it is preferred to stop the movement of the bulk parts M in the channel interior 10 to support the cleaning. At this, individual bulk parts M are preferably stopped in the surrounding of a specifically selected air supply opening 34 or a media supply opening 35 or an air or media discharge opening 36 for a chosen time period (see FIGS. 7 and 8). In this way, the cleaning is adapted to specific geometry features of the individual bulk parts M.

The media supply and discharge is specifically adjustable by means of conduits 34, 35, 36 in the channel block 30. To this end, preferably via a cleaning module (not shown) a cleaning media is introduced by means of a connection 33 into the supply conduit 35 and thereby into the channel interior 10. The shown supply 35 and discharge conduits 36 are adjustable by mounted valves and/or throttles in their flow-through characteristics. Such valves and/or throttles close preferably completely or partly specific conduits or provide an interruption or bypassing of the media to a defined position in the channel interior 10. It is further preferred to control valves and/or throttles specifically, preferably electronically, and to open, to close and/or to adjust them thereby.

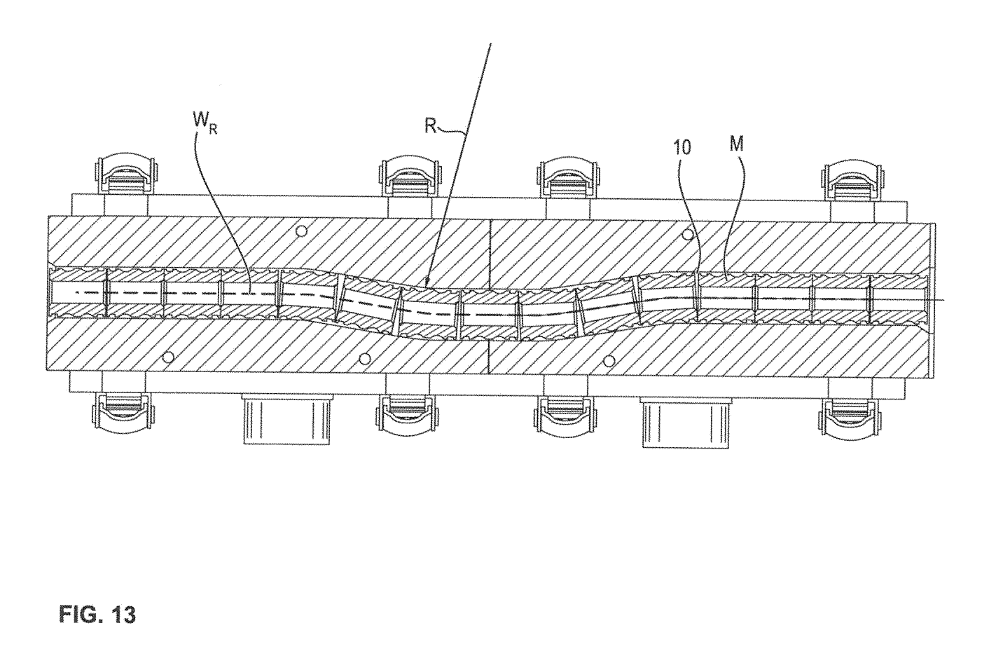

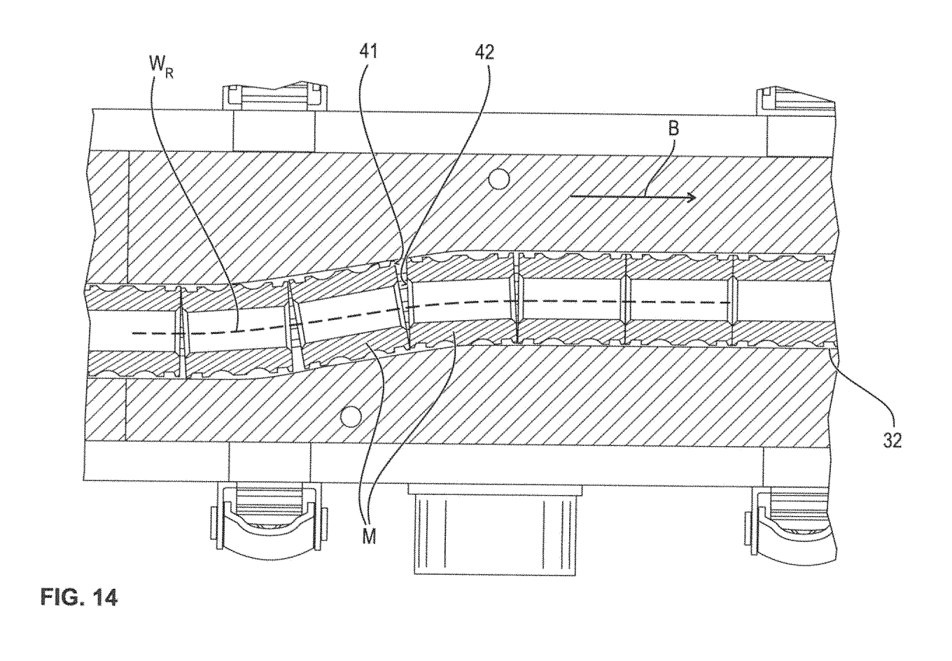

FIGS. 7 to 8 and 12 to 14 show preferred embodiments of how the forced advance moves the bulk parts M through the channel interior 10. With respect to the movement direction B, the front ends 41, 42 of adjacent bulk parts M abut each other to move the bulk parts M by means of mutual abutment through the channel interior 10. As far as the channel interior 10 extends straight, the axial front ends 41, 42 of the bulk parts M which abut each other cover each other. Here, the bulk parts M are moved along a straight cleaning path W_{R} (see the dotted line in FIG. 7). Due to this, the access for air and cleaning media to the front ends 41, 42 and the further geometry features of the bulk parts M being present there, as for example a blind hole 44, is prevented or at least made difficult. Due to this, the cleaning is only possible in a restricted manner.

Therefore, it is inventively preferred to guide the bulk parts M by means of at least one, preferably a plurality of chicanes 50 along an at least partly curvilinear cleaning path W_{R} in the channel interior 10 (see FIG. 8).

As far as the channel interior 10 extends straightly free of interference, adjacent bulk parts M support each other areally on the axial front ends 41, 42. Accordingly, the bulk parts M follow an almost straight cleaning path W_{R} in the channel interior 10. For making the covered front ends 41, 42 and further their arranged geometry features 44 accessible for the cleaning, it is inventively preferred to arrange at least one chicane 50, preferably a plurality of chicanes 50, in the channel interior 10. The chicanes 50 are preferably arranged at the inner channel wall so that they protrude into the channel interior 10. Preferably, a chicane 50 reduces a channel width perpendicular to the movement direction B by up to 50%, preferably by up to 10-30%. Further preferred, the chicanes 50, 50′, 50″ are arranged with respect to the cross-section of the channel 32 in an angle range β around the channel center, which extends over preferably β=270°, further preferred β=180°. To this end, the channel bottom side on which the weight force of the bulk parts M acts with a maximum forms the angle bisector of the given angle β. In the case of the channel 32 with round cross-section, this is the lowest point P facing the basis 14. At the channel 32 with rectangular cross-section, this point P is also located at the bottom of the channel 32 (see FIG. 3).

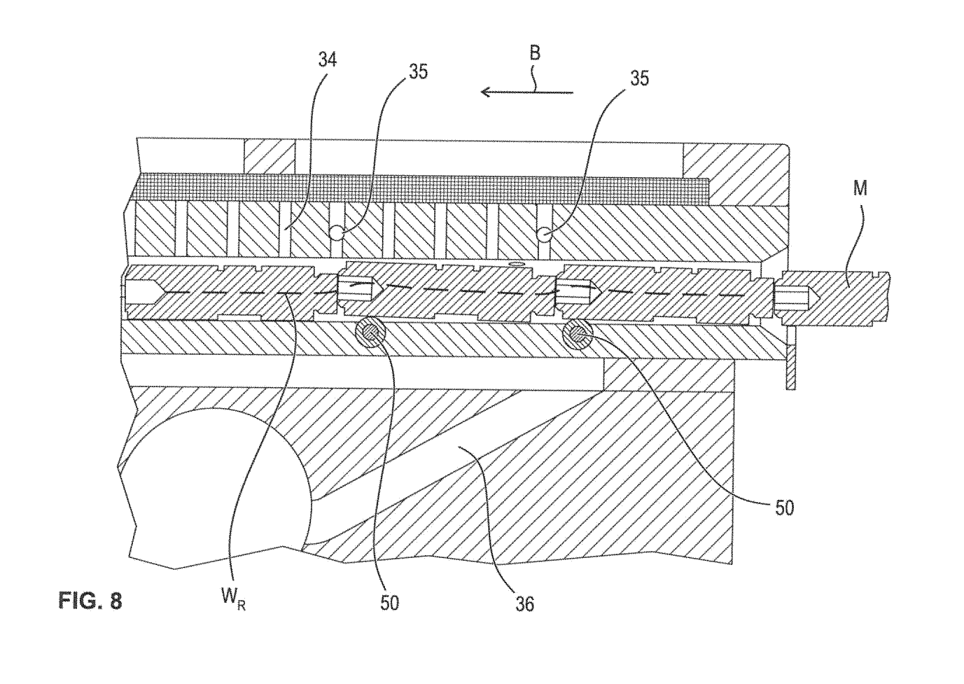

As can be seen based on FIG. 9, the chicane 50 protrudes into the channel interior 10 and turns the bulk parts M away from the straight cleaning path W_{R} to a curvilinear cleaning path W_{R}. This leads to a temporarily tilting of adjacent bulk parts M with respect to each other. Due to this, the front ends 41, 42 are also tilted with respect to each other and are released from the mutual abutment. This tilting allows the access of air and/or a cleaning media to the front ends 41, 42 and to the blind hole 44. To this end, the cleaning media is supplied preferably by means of the supply conduit 35. The supply conduit 35 opens therefore adjacent to the chicane 50 into the channel interior 10.

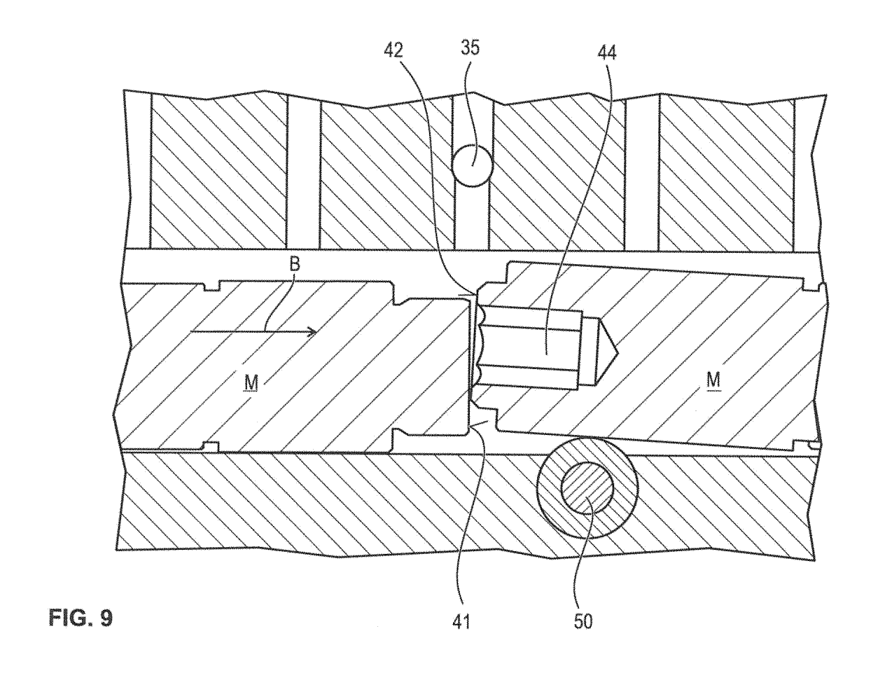

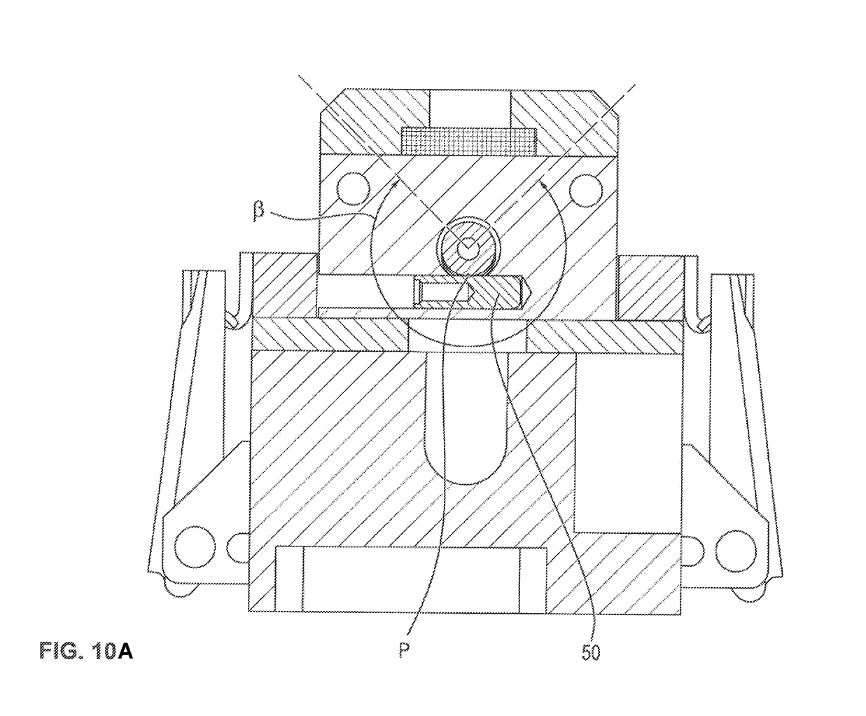

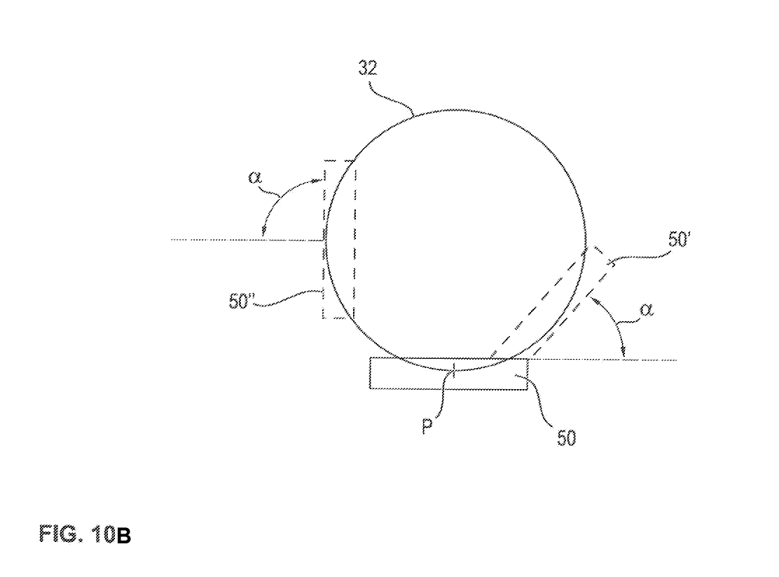

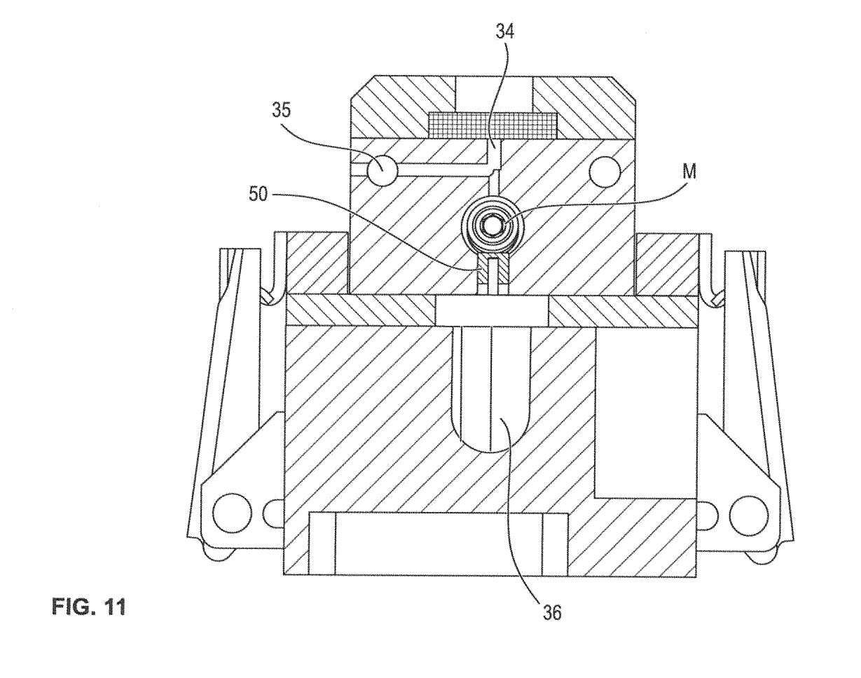

Inventively preferred, several chicanes 50 are equally spaced at the inner side of the channel 32 facing the basis 14. Further preferred, the chicanes 50, 50′, 50″ are arranged in the angle range β perpendicular to the movement direction B with an inclination a in the range of 0°<α≦90°, preferably 20°≦α≦90° with respect to the lowest point P or the tangent in the lowest point P of the channel 32. This is preferably shown in FIG. 10B. At this, the chicane 50′ can reduce the channel interior 10 as secant or as a radial protrusion (see FIG. 11) and create thereby a curvilinear cleaning path W_{R}.

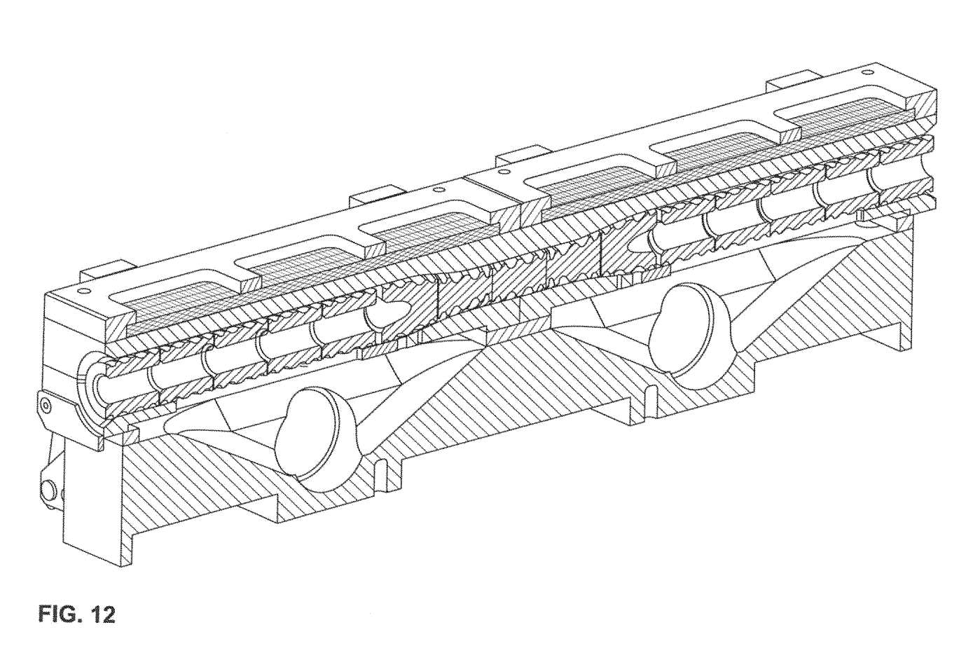

According to a further preferred embodiment of the present invention, the channel 32 is curvilinear shaped as shown in FIGS. 12-14. The course of the channel interior 10 follows a preferred radius of curvature R which releases the adjacent front ends 41, 42 from their abutment. In this regard, for the achieved effect the already above-mentioned applies with respect to the chicanes 50.

Preferably, the curvilinear course of the channel interior 10 has a radius R of curvature in the range of 2 to 3 times the length of the bulk part M. The radius of curvature can be, however, and depending on the shape of the bulk part M, greater or smaller if the geometry of the bulk part M requires it. Due to this, preferably a jamming of the bulk parts M in the channel interior 10 is avoided and/or a preferred opening angle of ≦40° between the front ends of adjacent bulk parts M is created.

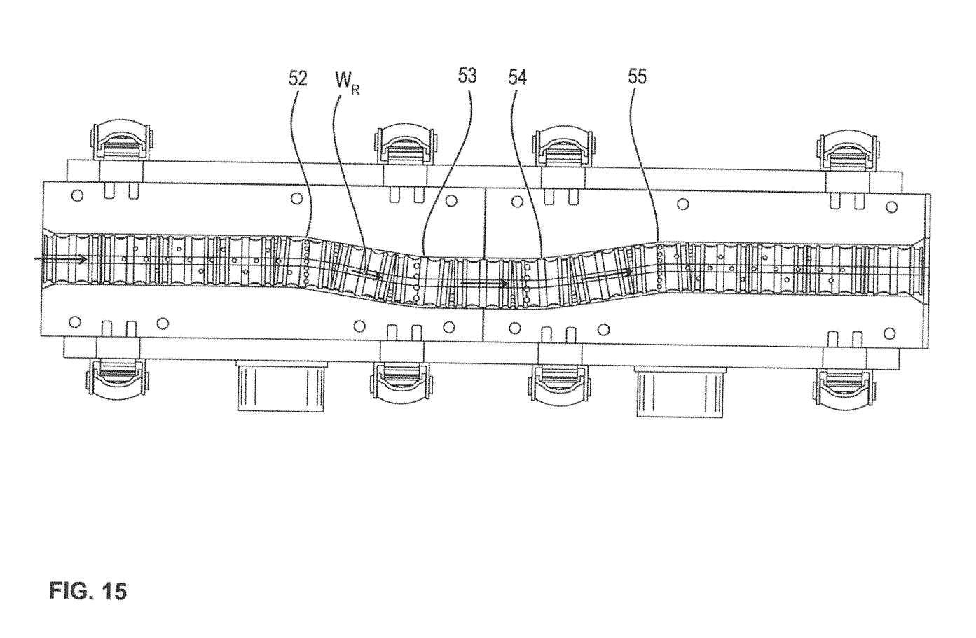

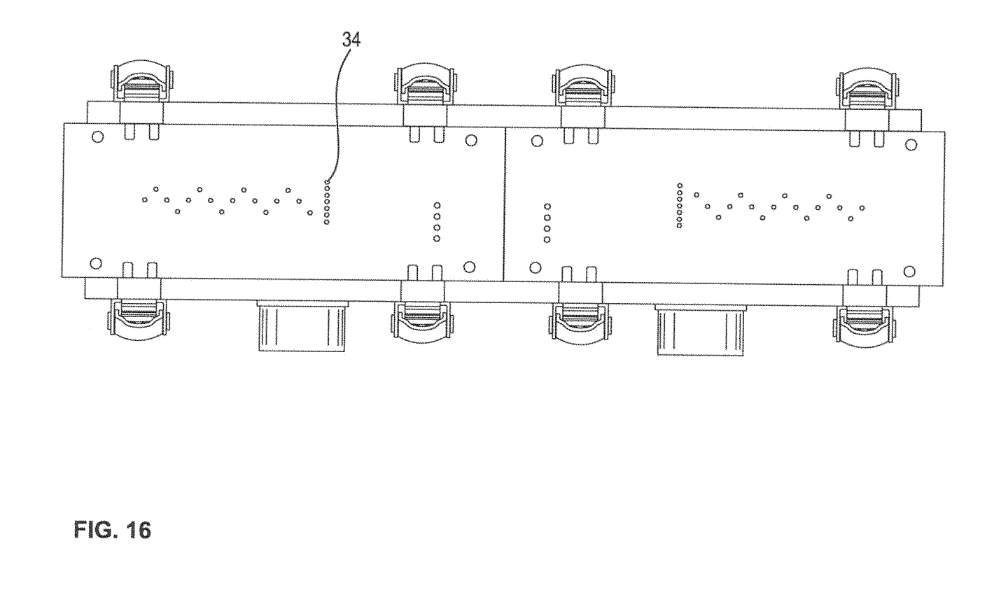

As can be seen based on FIGS. 15 and 16, surrounding air is sucked into the channel interior 10 and over the surfaces of bulk parts M especially at the positions where a straight section of the channel 32 transitions into a curvilinear section of the channel 32. Because especially in this portion of a change of direction of the cleaning path W_{R} at the locations 52, 53, 54, the front ends 41, 42 are opened by a specific opening angle (see above), thus free and in punctual abutment with each other at the most. At this locations 52, 53, 54, preferably several air supply openings transverse to the movement direction B are arranged. Thus, preferably the angular gap between the front ends 41, 42 is sucked off. It is also preferred to arrange the curvilinear course in each arbitrary spatial plane. By an arrangement of entrance and discharge openings for the at least one cleaning media in the course of the curvilinear channel interior 10, preferably in a turning portion, also a flowing-through and cleaning of bores or geometry features of the bulk parts M in the component interior is achieved. Thus, corresponding through holes or blind bores, punctures or other inner cross-sections of the bulk parts M even with undercuts can be cleaned in the channel interior 10.

The design of abutment surfaces of the bulk parts M on a wall of the channel interior 10 has further an influence on the cleaning quality and starts already with the guiding and conveying of the bulk part M prior to the actual cleaning channel. The dimension of the contacting surface between bulk part M and supporting surface is a measure for a) surfaces which are not accessible for the cleaning, which have to be made accessible by vibration if necessary, b) dragging of dirt in movement direction and into the channel interior, and c) creation of disadvantageous frictional forces which have to be overcome by the conveyor device. If for example rings lying on the front end are moved through the channel interior and if the channel bottom is preferably plane, a contamination with oil leads to the above-mentioned problems.

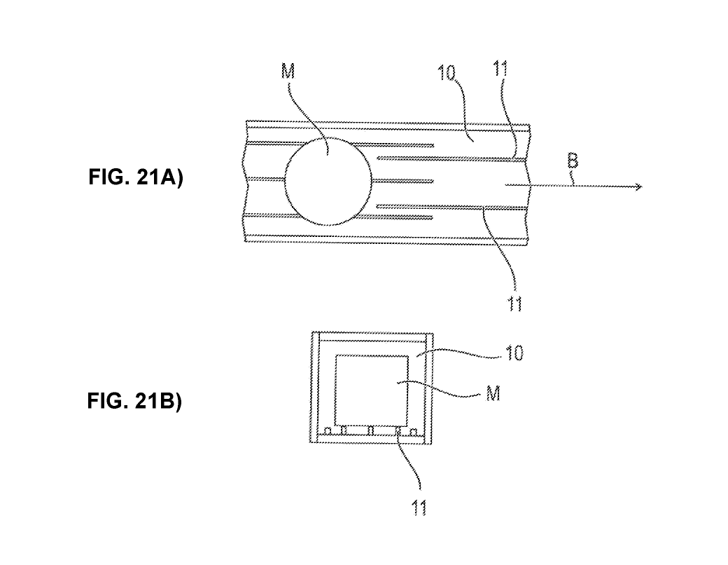

A solution consists in that the supporting surface between bulk part M and channel inner wall are reduced so that a reliable movement of the bulk part through the channel interior is given. Further, it is preferred to change the supporting surface in the course of the movement of the bulk part M through the channel interior 10 along the cleaning path to allow the access of cleaning media, like air and/or liquid, to almost all surfaces of the bulk part. Therefore, the bulk parts M are guided preferably on the channel inner wall on which they lie during their movement along the cleaning path and/or at which they abut by means of supporting webs 11 (see FIGS. 21A, 21B). These supporting webs 11 protrude into the channel interior 10. In the channel interior 10 they extend in movement direction of the bulk parts M continuously or sectionally pierced or broken. By means of these interruptions of the continuously extending supporting webs 11, supporting surfaces of the bulk part are made accessible for the cleaning. Further preferred, the supporting webs extend at least sectionally into the channel interior in an acute angle to the movement direction or to the cleaning path of the bulk parts. By means of this inclined course, the bulk parts are preferably rotated in the channel interior or displaced around the longitudinal axis to make almost all surface portions of the bulk parts accessible for the cleaning. Further, it is preferred to create an asymmetric friction with respect to the cross-section of the bulk part by means of the supporting webs. This asymmetric friction creates in combination with the forced advance a rotation of the bulk part to support the cleaning. Such a bulk part rotation is preferably also created by specific fluid dynamics or fluid mechanics in the channel interior.

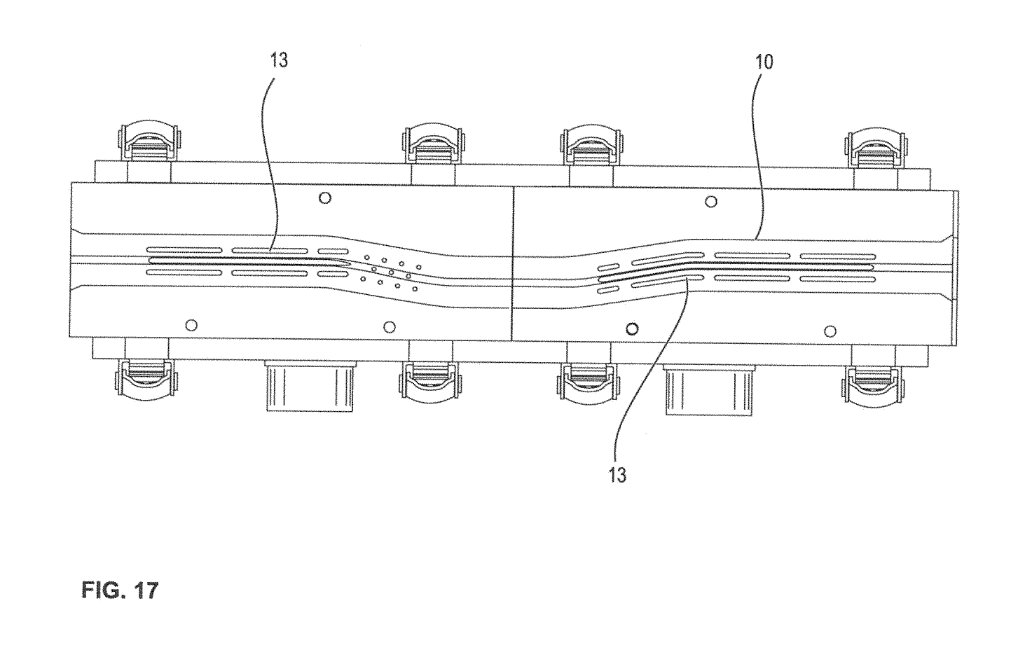

Further, it is preferred to change the support or the contact between bulk part M and channel interior 10 instead of supporting webs by means of holes, elongated holes 13, grooves and generally recesses. This is according to a preferred embodiment shown in FIG. 17. FIG. 17 shows a view of connected channel segments K from the bottom. In the bottom of the channel segments K, several elongated holes are arranged which form also a web-like support for the bulk part M in the channel interior 10. These elongated holes 13 create with a preferred angular arrangement with respect to the movement direction B a moment in the bulk part M so that this is rotated during its movement in the channel interior 10. The constructive design of the elongated holes changes also the dimension of the contact surface between bulk part M and inner channel wall whereby the same effects as with the above-described supporting webs are achieved. Further, it is possible to guide air or cleaning media by means of such openings onto the bulk part M.

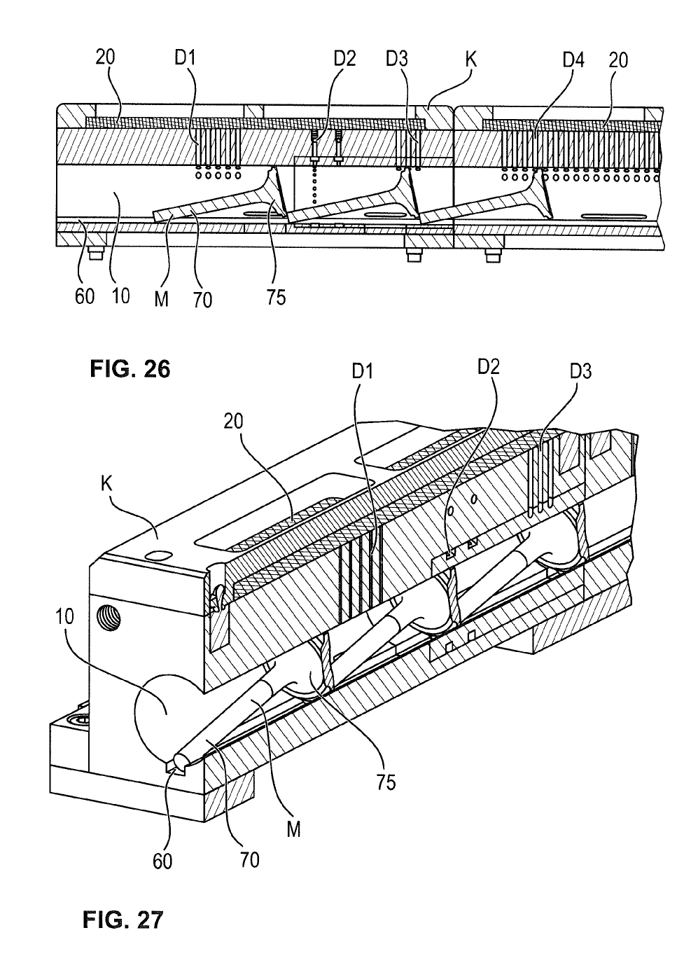

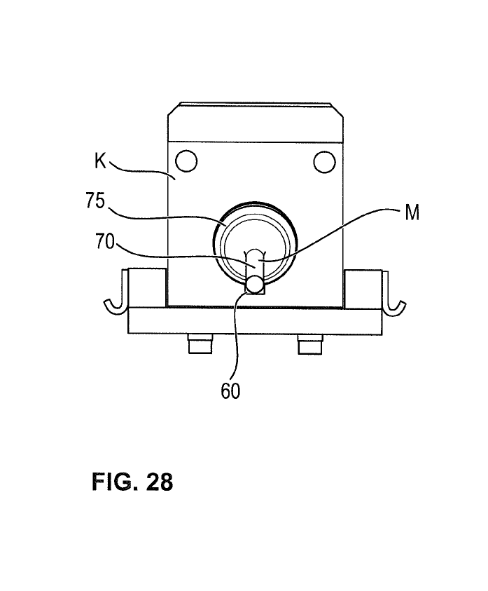

In a further preferred embodiment shown in FIGS. 26 to 28, the channel segment K comprises a recess 60. With respect to the general construction of the channel segment K, it is also referred to the description of the further embodiments of the channel segment K. At this, individual features of the different embodiments can be combined with each other. By means of the recess 60, for example cylindrical workpieces to be cleaned as bulk parts consisting of a shaft 70 and a head or disc 75 of different diameter are especially advantageously guidable in the channel interior 10. The work pieces to be cleaned are for example valve plungers, screws, nails, rivets and the like.

The recess 60 is adapted to a shaft diameter of the workpieces to be cleaned, whereas the channel interior 10 on the whole is adjusted to a head or disc diameter. The recess 60 may extend advantageously over the complete channel segment K or may be present only in part sections. For example, at the beginning and the end of the recess, a ramp like structure may be present to guide the shaft 70 into and out of the recess 60.

By means of the recess 60, the contact surface of two adjacent and each other abutting work pieces to be cleaned is further minimizable at the front ends, especially compared to an embodiment without recess 60. Thereby, the surface being readily accessible for the cleaning is further increased.

As can also be seen in the embodiment of the FIGS. 26 to 28, different nozzle groups D1 to D4 are provided. Air is supplied by means of the nozzle groups D1 and D3, which each comprise a plurality of nozzles being arranged in supply direction of the work pieces to be cleaned besides each other and extending in circumferential direction for example only over a sub-portion of the channel interior 10. Before the air reaches the channel interior, it is guided through a filter 20, as has been described above. The supplied air can be surrounding air or preferred heated air, as described in combination with the embodiment according to FIGS. 23 to 25. Especially preferred, it is air which has already been cleaned, regardless of whether the air is present already heated or at surrounding temperature.

By means of the nozzle group D2, especially a liquid cleaning medium is supplied. The nozzle group D2 comprises also a plurality of nozzles being arranged in supply direction of the work pieces to be cleaned besides each other. In contrast to the nozzles of the nozzle groups D1 and D3, the nozzles of the nozzle group D2 are provided along the complete circumference of the channel interior 10.

Via the nozzles of the nozzle group D4, finally air is supplied again, preferably filtered surrounding air for cooling the work pieces or bulk parts M to be cleaned. It is especially preferred that the supplied air is cooled so the the bulk part M to be cleaned is surrounded or flowed around by air having a temperature below the temperature of the surrounding air. In this way, the bulk parts M to be cleaned can be cooled specifically so that they can be processed further directly after the cleaning process. As far as a specific end temperature of the bulk part after the cleaning is not required, heated air can also be supplied via the nozzles of the nozzle group D4 which improves a drying process. The nozzle group D4 is constructed in analogy to the nozzle groups D1 and D3 has, however, in supply direction of the bulk parts M more nozzles being arranged besides each other compared to the nozzle groups D1 and D3.

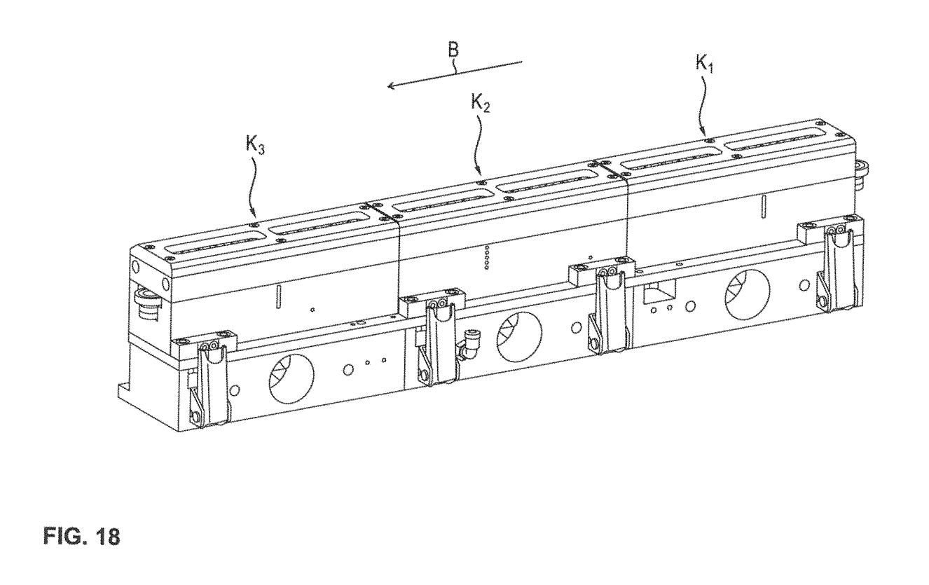

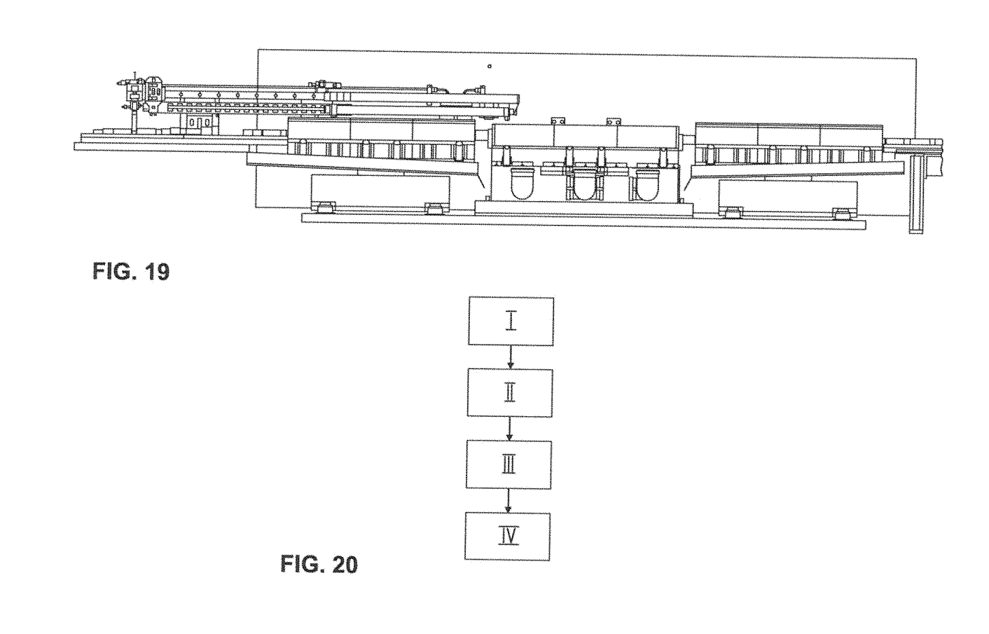

The FIGS. 18 and 19 show the preferred combination of several channel segments K to one cleaning zone. According to an embodiment, three channel segments form always one cleaning zone in which the bulk part M is cleaned only with one specific cleaning media or with cleaning media and vibration or only with air or with air and vibration. These cleaning zones are constructed preferably according to the above-described construction alternatives of the channel segments K.

The channel of a run-through cleaning device shown in FIG. 18 is a channel with three channel segments K1, K2 and K3. In the first channel segment K1 in moving direction B, a processing media of the last machining process, as for example a coolant of a milling process, is cleaned off from the bulk parts M and discharged or removed. After removal from the channel interior 10, preferably a recycling of the air used for the cleaning or of the cleaning media occurs. In the second channel segment K2, remaining residues are cleaned off, preferably with another cleaning media compared to the channel segment K1. Due to this, it is preferably prevented that the cleaning media of the respective channel segment K1, K2 is dragged into the respective other channel segment K1, K2. In the third channel segment K3, preferably the bulk parts M are dried from the adhering cleaning media.

In FIG. 19, also an arrangement of three channel segments K1, K2, K3 is shown like described in FIG. 18. Here, in channel segment K1, the processing auxiliary material is cleaned off as described above. In channel segment K2, the residues, for example particles and fluidic contaminations, are cleaned off with a cleaning fluid. In segment K3, a drying occurs. In channel segment K2, a further after processing of the bulk parts M may also occur preferably, like the removing of residues of the cleaning fluid by means of the rinsing media and a subsequent drying in the channel segments K1 and K2. In channel segment K3, preferably a specific after-treatment occurs, as for example the applying of a conservation, and in the channel segments K2 and K3 the reducing of the conservation layer to a desired and required amount, as for example dry, non-drip, wetted or slightly damp.

For preventing a dragging of media into another channel segment K or in another cleaning zone, blocking air, pressure sinks or air curtains or mechanical separations between the channel segments K are used. An air curtain or a blocking air in the channel interior 10 is created by means of several closely to each other arranged air supply openings 34 or by air supply openings 34 of larger cross-section. By means of this arrangement, a larger volume flow as in the air supply openings 34 destined for the cleaning is achievable. Further, the air supply openings 34 for the air curtain are arranged adjacent to discharge openings or pressure sinks. By means of this, short air paths to the pressure sink and a small flow resistance are achieved which supports the effect of the air curtain. In this way, a comparatively high volume flow is generated which due to its flow power in longitudinal direction of the channel interior 10 catches and discharges squirting or flowing media before it can get into an undesired portion of the channel interior 10 or the run-through cleaning device.

According to a preferred embodiment of the run-through cleaning device, in a first drying process zone machining residues are removed from the bulk parts M. This occurs by means of the supply of air to and vibration of the channel segments K belonging to this cleaning zone. Accordingly, the vibrations detach the contaminants from the surface of the bulk parts M so that they are subsequently sucked off by means of the air stream of surrounding air.

In a further, preferably subsequent, wet process zone, further machining residues are removed from the surfaces of the bulk parts M by means of a wet chemical process. Here, for example the supply conduits 34 serve for applying specifically a liquid cleaning medium or several liquid cleaning media to the surfaces of the bulk parts M. Due to this, the surfaces of the bulk parts M are practically cleaned from machining residues in this cleaning zone.

In a further and preferred subsequent cleaning zone, a drying process occurs. Here, preferably residues of the prior used cleaning medium are removed by means of air and/or vibrations from the surface of the bulk parts M. Further, an air stream flowing over the surface of the bulk parts M is used for drying the bulk parts M.

A preferred embodiment of the cleaning method is shown in the flowchart of FIG. 20. Here, step I means the moving of the bulk parts M in a row with mutual abutment through at least one channel segment K by means of the conveyor device outside of the channel segment K. According to step II, the bulk parts are supplied with air in the channel interior 10. Further preferred, in step III the bulk parts M in the channel interior 10 are supplied with a liquid cleaning medium. In the scope of these cleaning steps, it is further preferred to move the bulk parts M along an at least partly curvilinear cleaning path W_{R}. Optionally, also the already above-discussed step of vibrating (step IV) may be used.

Now referring to FIG. 23, a schematic depiction of a preferred embodiment of the inventive run-through cleaning device using air as cleaning medium is shown. The system for guiding the air as cleaning medium is here denoted with 100. Fresh air or surrounding air, depicted as dotted arrow 102, is sucked in by a compressor 120 into a channel segment K. In the channel segment K, the surrounding air 102 flows via a nozzle 110 into the channel interior 10, in which the work pieces to be cleaned are guided. Accordingly, a contamination on the work pieces is sucked off and especially not blown off.

The surrounding air laden with contaminants, illustrated by the arrow 104, is now supplied to a cyclone separator 115 as separation device for the contaminants. Subsequently, the cleaned surrounding air flows through the compressor 120 and is heated there due to the dissipation power of the compressor 120 as well as the compression of the air.

For avoiding an increasing of the room temperature, the heated cleaned air is guided after the compressor 120 through a heat exchanger 130, preferably an air/liquid heat exchanger. The liquid heated in this way can be dissipated or it can be used for heating purposes. The cooled and cleaned air can be supplied to the surrounding by means of an air discharge conduit 106. The cooling power of the heat exchanger is controlled by a temperature sensor T in the air discharge conduit 106 in combination with a valve 132 in the fluid conduit downstream of the heat exchanger 130.

FIG. 24 shows an improved and preferred embodiment. In contrast to the above embodiment, the cleaned and heated air is supplied from the heat exchanger 130 via a return conduit 135 back to the channel segment K. In this way, a circular flow or cycle is formed for the air as cleaning medium. An advantage of this is that due to the usage of heated and cleaned air the possible entry of contaminants from the outside is reduced. This applies specifically in case solely cleaned and heated air is used. Form or shape nozzles 110 being present in the channel segment K can thus be used without change. Optionally, filter mats on the nozzles 110 may be avoided due to the clean heated air which reduces the maintenance effort of the run-through cleaning device respectively.

Due to the heated air as cleaning medium, either the cleaning efficiency or the throughput of the run-through cleaning device in the respective channel segment K can be increased. This is based on the fact that for example the viscosity of oil being present as contaminant is reduced due to the cleaning with heated air. Accordingly, the oil is present in smaller drops or beads and can be detached or released more easily from the workpiece.

Additionally, a fresh or surrounding air supply conduit is provided so that further surrounding air 102 as cleaning medium can be supplied to the channel segment K. The surrounding air 102 may be filtered and/or sucked in with a fan, which is described further below in detail in combination with a further preferred embodiment.

In the embodiment according to FIG. 24, the power of the heat exchanger is regulated depending on the temperature in the channel segment K. For controlling or regulating the temperature of the heated air in the circular flow, a temperature sensor T is provided in the channel segment K by means of which the valve 132 in the liquid conduit downstream of the heat exchanger is regulated. In this way, the temperature of the air used for the cleaning can be predetermined specifically. If the temperature of the heated and cleaned air in the return conduit 135 is not sufficiently high, a separate heating device can be provided in the return conduit 135.

Especially at oil as contaminant and due to the safety at work, it is preferred that the temperature of the heated air in the channel segment does not exceed preferably about 80° C. and especially preferred about 70° C. A lower limit for the temperature of the heated air in the channel segment is preferably at about 50° C. Especially preferred, the temperature of the heated air is about 65° C. With respect to the air temperature in the compressor, an upper limit of 120° C. should not be exceeded due to the flash point of the oil. In total, the cleaning efficiency can be increased by about 40% in this way compared to non-heated air. Further, the cleaning efficiency is better controllable as especially seasonal variations of the temperature of the surrounding air have no influence on the temperature of the heated air due to the circular flow of the air.

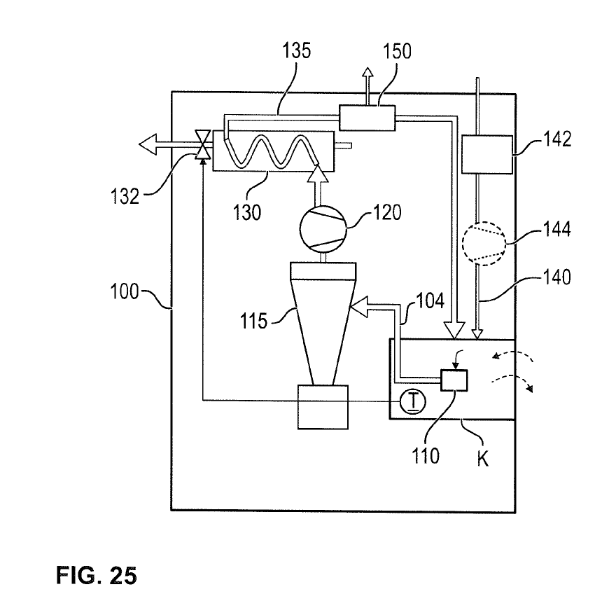

The embodiment according to FIG. 25 differs from the embodiment according to FIG. 24 in that a bypass 150 is provided in the return conduit 135 of the cleaned heated air. In this way, cleaned and heated air can be discharged to the surrounding. For example between 0 and 50%, preferably 10 to 20% of the volume flow of heated cleaned air sucked in by the compressor can be discharge via the bypass 150.

Additionally, a fresh air conduit 140 is provided in which a filter 142 and a fan 144 are arranged. By means of the fresh air conduit 140, quantitatively especially the volume flow which has been discharged by the bypass is supplied again. This means that 0 to 50% of the volume flow sucked in by the compressor 120 can be supplied via the fresh air conduit 140. If for example 10% of the volume flow are discharged by the bypass 150, then 10% are supplied again by means of the fresh air conduit 140.

Due to this construction, on the one hand cleaned and heated air can be supplied to the channel segment K for improving the cleaning efficiency. On the other hand, surrounding air being already cleaned due to the filter 142 can be supplied to the channel segment K so that the cleaned workpiece can be cooled at least partly. A respective separation in the channel segment K can for example occur by means of fluid mechanics so that an air mass distribution takes place by means of a specific air guiding in the channel segment K. If no heated air is discharged to the surrounding via the bypass 150, the operation is similar to the above-described embodiment without bypass 150.

By means of the fan 144, fresh air or surrounding air can be pressed into the channel segment K. Due to this it is avoided that unfiltered surrounding air is sucked in via leakages being possibly present. A possible contamination of the work piece to be cleaned due to contaminants in the surrounding air is thus further minimized.

The heated and/or surrounding air is or are blown into the channel segment K in which the cleaning path is present. The cleaning path receives the work piece to be cleaned and forms a nozzle 110 in combination with the work piece to be cleaned via which air is sucked off from the channel segment. The air is supplied to the channel segment K in such a manner that no suction via leakages or similar occurs but that the supplied heated and/or surrounding air, which is preferably sucked in via nozzles, flows in an appropriate manner through inlet nozzles into the cleaning path. The advantage is that existing cleaning paths can be used further without amendments and/or enhancements. The cleaning efficiency is advantageously determined by the air guiding in the channel segment K. Further, it is preferred to improve the cleaning efficiency additionally by means of the adaption of the power of the used industrial manufacturing equipment to the bulk parts M to be cleaned.

Based on the above embodiments and with respect to the cleaning method, it is thus preferred that the supplying of air occurs with air being heated above the surrounding temperature and/or being cleaned compared to the surrounding air. At this, it is especially preferred if a suction conduit out of the channel interior is connected to the air supply conduit to provide a circular flow for cleaned heated air. Additionally, a supply of surrounding air can occur which is either sucked into the channel segment by a compressor being already present or which is supplied into the channel segment by means of an individual fan. In both cases, a cleaning of the surrounding air can occur by means of a filter before the surrounding air enters the channel segment. In combination with the fan, the filter is preferably arranged upstream of the fan. A controlling of the temperature of the heated air can occur by means of a heat discharge device and/or a heating device.

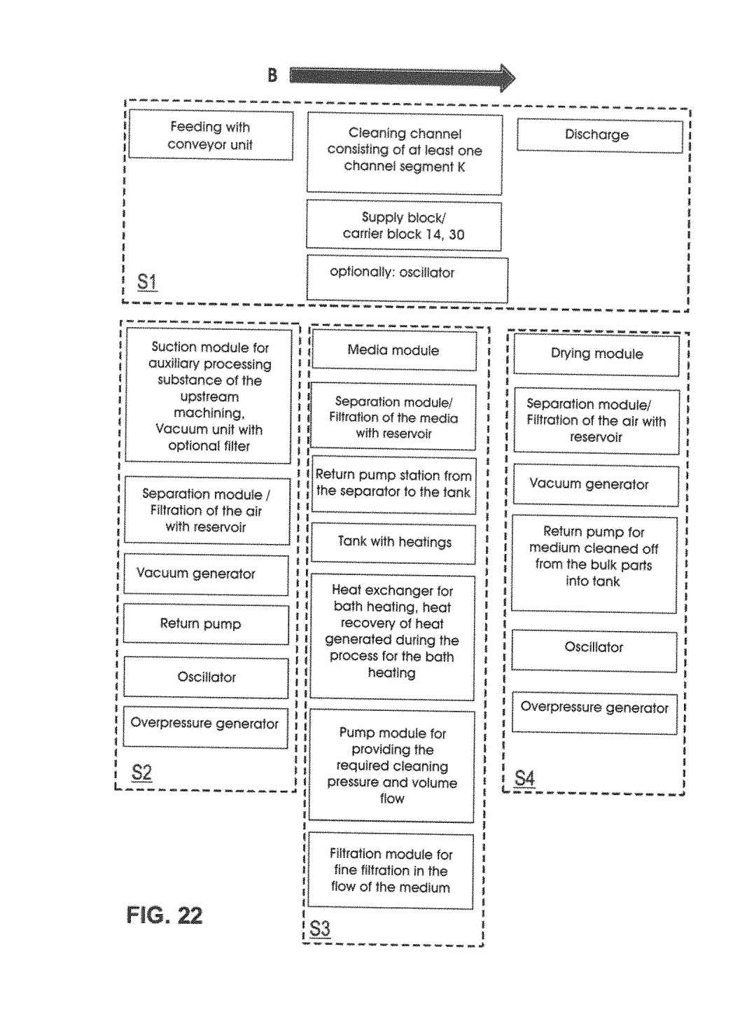

FIG. 22 shows a block diagram of a preferred embodiment of the inventive run-through cleaning device. While the arrow B indicates the movement direction of the bulk parts M through the at least one channel segment K, the group S1 denotes a minimum configuration of the run-through cleaning device. It consists preferably of a conveyor unit outside of the channel interior 10 by means of which the bulk parts M can be supplied to the cleaning. The cleaning channel is minimally formed by one channel segment K which is supplied with at least one cleaning media, here preferably air, by the connected basis 14 and channel block 30. The air is also sucked off via the basis 14. At the end of the channel segment K, the discharge of the cleaned bulk parts M occurs with a further conveyor unit. Optionally, the here described basic configuration is supported by supplying vibrations by means of an oscillator or vibrator.

The further shown groups S2, S3 and S4 show module groups and their structure, which can be used in arbitrary number according to the cleaning requirement in the run-through cleaning device. According to a preferred embodiment, the group S2 is used for pre-cleaning the bulk parts M. To this end, a suction module works with a vacuum unit and a filter to remove machining residues and auxiliary materials from the bulk parts M. For being able to influence the flow characteristics at the bulk part, additionally an overpressure unit, as for example a compressor, is provided. A return pump guides the cleaned materials into a separation module with filtration for separating here the machining media, as for example chippings, from the cleaning media as for example air or water. At this, and with reference to the embodiment of FIGS. 24 and 25, heated cleaned air can be provided as it has been described above.

For being able to provide sufficient cleaning media to the run-through cleaning device, preferably the media module is used with its periphery components according to group S3. The periphery components ensure that a cleaning media is supplied (pump module) and discharged cleaned (separation module with return pump station). In a tank in which cleaning media is present, the cleaning media is optionally heated. This is also possible by means of an optional heat exchanger in which heat recovered from the cleaning process is supplied again to the cleaning process for example by means of a heat exchanger.

In an optional drying module according to group S4, the air for drying the bulk parts is used and subsequently collected and cleaned. This cleaning section is preferably supported by an overpressure generator and/or oscillator or vibration generator and/or vacuum generator. Also in this module, heated cleaned air can be provided, as it has been described above in combination with the embodiment according to FIGS. 24 and 25.

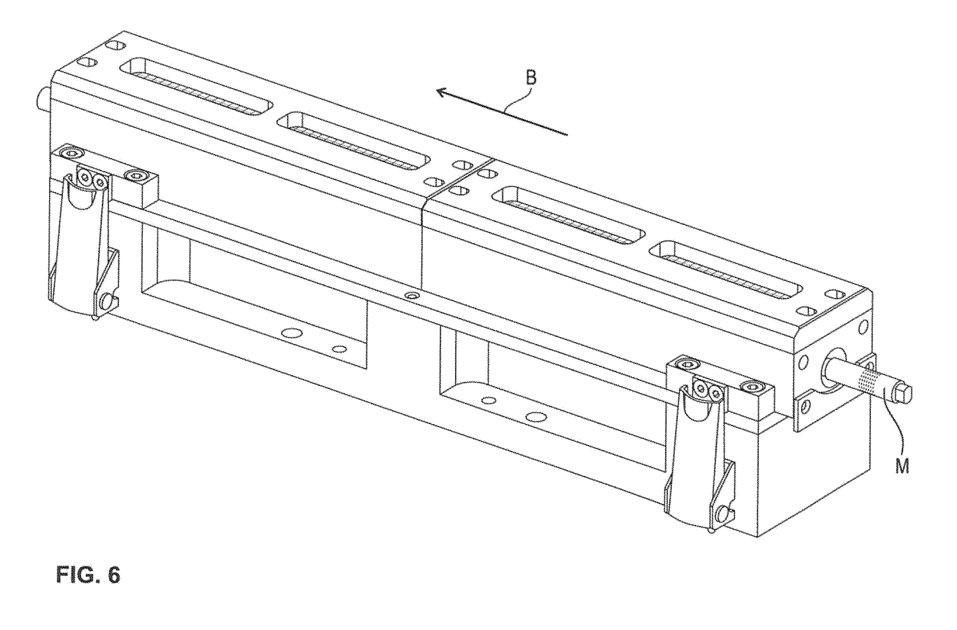

### LIST OF REFERENCE SIGNS FOR FIGS. 1-28

K modular channel segment
M bulk part
B movement direction
W_{R} cleaning path
10 channel interior
11 supporting web
12 quick release system
13 elongated hole
14 basis
16 media conduit
18 connections
20 filter
22 holder
30 channel block
32 channels
33 connection
34 supply conduits
35 supply conduit
36 discharge conduits
41, 42 front ends
44 blind hole
50 chicane
T temperature sensor
100 system for guiding the air
102 surrounding air
104 surrounding air with contaminants
106 air discharge conduit
110 nozzle
115 cyclone separator
120 compressor
130 heat exchanger
132 valve
135 return conduit
140 fresh air conduit/surrounding air conduit
142 filter
144 fan
150 bypass
D1 first group of nozzles
D2 second group of nozzles
D3 third group of nozzles
D4 fourth group of nozzles
60 recess
70 shaft
75 disc or head
These and further modifications and variations of the subject concepts intended to cover the present invention will be apparent to those of sufficient skill, according to the following claims.

1. A run-through cleaning device for bulk parts, comprising:
at least one modular tunnel-like channel segment through which the bulk parts are movable in a longitudinal direction along a cleaning path in a channel interior,
a conveyor device of the bulk parts which is arranged outside of the at least one channel segment and by means of which the bulk parts are movable in a row with mutual abutment of adjacent bulk parts through the at least one channel segment in a movement direction, wherein the channel interior defines constructively an at least partly curvilinear course of the cleaning path, whereby an arrangement of adjacent bulk parts to each other is changeable during a movement through the channel interior, and
a plurality of supply conduits, which are distributed over the channel segment, into the channel interior and at least one discharge conduit out of the channel interior.

2. The run-through cleaning device according to claim 1, in which the supply conduits further comprise at least one supply conduit of a liquid cleaning medium and a discharge conduit out of the channel interior.

3. The run-through cleaning device according to claim 1, in which the at least one channel segment is fastened and replaceable or exchangeable by means of a quick release system.

4. The run-through cleaning device according to claim 1, in which the supply conduits comprise a plurality of air supply conduits which are connected to a surrounding of the run-through cleaning device via a filter, and in which the at least one discharge conduit is a suction conduit which creates a reduced pressure or vacuum.

5. The run-through cleaning device according to claim 4, in which the at least one channel segment has a plurality of chicanes which protrude into the channel interior so that adjacent bulk parts are changeable in an orientation with respect to each other during a movement through the channel interior.

6. The run-through cleaning device according to claim 5, in which the plurality of chicanes comprise at least one of a plurality of chicanes protruding against a weight force of the bulk parts into the channel interior and a plurality of chicanes protruding lateral to the movement direction into the channel interior.

7. The run-through cleaning device according to claim 4, in which the channel interior extends curvilinear.

8. The run-through cleaning device according to claim 1, in which at least two channel segments are arranged in the movement direction in succession to provide different cleaning zones, wherein the channel segments are separated from each other by at least one of a spaced arrangement, an air curtain and a pressure sink.

9. The run-through cleaning device according to claim 1, in which the at least one channel segment can be vibrated.

10. The run-through cleaning device according to claim 1, in which the supply conduits comprise at least one air supply conduit for heated air in connection with a suction conduit as discharge conduit of the at least one channel segment via a separation device so that at least a part of the air used for the cleaning is moved in a circular flow.

11. The run-through cleaning device according to claim 10, further comprising a heat discharge device provided in the circular flow of air, the power of which can be adjusted or regulated depending on the temperature in the at least one channel segment.

12. The run-through cleaning device according to claim 10, further comprising a bypass in the circular flow of the air so that air can be discharged to the surrounding, wherein the supply conduit comprises further a fresh air conduit for supplying surrounding air.

13. The run-through cleaning device according to claim 12, in which a fan is provided in the fresh air conduit so that an overpressure can be provided in the at least one channel segment.

14. A modular tunnel-like channel segment of a run-through cleaning device through which bulk parts are movable in a longitudinal direction along a cleaning path in a channel interior which defines constructively an at least partly curvilinear course of the cleaning path, whereby an arrangement of adjacent bulk parts to each other is changeable during a movement through the channel interior.

15. The channel segment according to claim 14, comprising a plurality of media supply conduits, which are distributed over the channel segments, into the channel interior and at least one discharge conduit out of the channel interior.

16. The channel segment according to claim 15, comprising at least one supply conduit of a liquid cleaning media into the channel interior and a discharge conduit out of the channel interior.

17. The channel segment according to claim 14, comprising a quick release system by means of which the channel segment is fastenable at a basis.

18. The channel segment according to claim 14, comprising a plurality of chicanes protruding into the channel interior so that adjacent bulk parts during a movement through the channel interior are changeable in an orientation to each other.

19. The channel segment according to claim 18, in which the plurality of chicanes comprises at least one of a plurality of chicanes protruding into the channel interior oriented against a weight force of the bulk parts and a plurality of chicanes being oriented lateral to the movement direction.

20. The channel segment according to claim 14, in which the channel interior extends curvilinear.

21. The channel segment according to claim 14, which can be vibrated in combination with an oscillator.
